(19) United States
(12) Patent Application Publication
(10) Pub. No.: US 2025/0103857 A1
(43) Pub. Date: Mar. 27, 2025

(54) DIVIDE AND ATTEND LONG RANGE BLOCK ATTENTION

(71) Applicant: CHAOS INDUSTRIES, INC., Hermosa Beach, CA (US)

(72) Inventors: Abhishek CHAURASIA, Hermosa Beach, CA (US); Andre Xian Ming CHANG, Hermosa Beach, CA (US); Shakti Nagnath WADEKAR, Hermosa Beach, CA (US); Shreya CHAKRABORTY, Hermosa Beach, CA (US)

(21) Appl. No.: 18/472,657

(22) Filed: Sep. 22, 2023

(51) Int. Cl. G06N 3/0455; G06N 3/0442; G06N 3/048; G06N 3/08

(52) U.S. Cl. CPC G06N 3/0455; G06N 3/0442; G06N 3/048; G06N 3/08

(57) ABSTRACT

An input is received with a layer of a neural network. The input comprises a sequence having an input sequence length. The input is divided into N blocks. Each of the N blocks comprises a sequence length that is shorter than the input sequence length. A first block output is determined for the first of the N blocks; and provided as input for determining a next block output for the next of the N blocks. These operations provide long range attention in a machine learning model for an input comprising any mode of data, and/or otherwise train a neural network of the machine learning model, with a longer data input sequence length compared to prior neural networks. In some embodiments, the neural network comprises at least a portion of an LLM. In some embodiments, the neural network comprises a transformer module of the LLM, for example.

### BACKGROUND

### 1. Field

The present disclosure relates generally to long range block attention.

### 2. Description of the Related Art

Large Language Models (LLM) are trained for Natural Language Processing (NLP) tasks such as text generation, text summarization, text sentiment analysis, and text translation. Using a large corpus of data (e.g., from the internet) a LLM is able to learn various complex concepts. A LLM can accomplish various text related tasks given a prompt that shows examples of how to perform a task. The LLM may generate better or worse results depending how the LLM is trained, how a prompt is formulated, how much information a prompt includes, and/or other factors. LLM's are often formed by one or more neural networks. LLM's typically include one or more neural networks that form transformer modules comprising a stack of transformer layers. The layers may include a multi-head attention layer, a normalization layer, a feed-forward layer, and an additional normalization layer, for example.

### SUMMARY

The following is a non-exhaustive listing of some aspects of the present techniques. These and other aspects are described in the following disclosure.

According to an embodiment, a method for providing long range attention in a machine learning model for an input comprising any mode of data is provided. The method comprises dividing the input into N blocks. Each of the N blocks comprises a sequence length that is shorter than an input sequence length. The input is received with a layer of a neural network of the machine learning model. The input comprises a sequence having the input sequence length. The method comprises determining a first block output for a first of the N blocks. The method comprises providing the first block output as one of the inputs for determining a next block output for a next of the N blocks. Providing the first block output as input for determining a next block output may comprise adding, combining, averaging inputting side by side, concatenation, aggregation, and/or other providing. The method comprises repeating some or all of these operations for each remaining block, such that each next block output is determined based on output from a previous block, thus merging smaller blocks to retain context associated with the input and provide the long range attention in the machine learning model. These operations facilitate providing the neural network with longer sequence lengths compared to what was possible with prior neural networks, by dividing the sequence length into smaller blocks to mitigate computational complexity, and subsequently merging the smaller blocks to retain the context associated with the input and provide the long range attention.

In some embodiments, a block output coming from multiple previous blocks comprises collective information from all of the multiple previous blocks.

In some embodiments, the input comprises text, numerical data, one or more images, an audio recording, radar data, a spectrogram, and/or (any) other modes of data.

In some embodiments, the method comprises converting the input into the sequence. The sequence has units associated with the input. A quantity of the units comprises the input sequence length. Each unit of the sequence may be converted into a vector and provided to the layer.

In some embodiments, the neural network comprises a transformer module of a large language model. In some embodiments, the layer of the neural network comprises a multi-head attention layer of the transformer module. In some embodiments, the multi-head attention layer comprises multiple self-attention modules, with each self-attention module associated with one of the N blocks. In some embodiments, the multiple self-attention modules are configured to operate in parallel.

According to another embodiment, a method for training a neural network with a longer sequence length compared to training of prior neural networks is provided. The method comprises (a) receiving an input (X) with a layer of a neural network. The input comprises a sequence having an input sequence length (ξ). The sequence may comprise characters, words, phrases, image pixels, an audio recording, radar data, a spectrogram, data bytes, and/or other units. Each unit of a sequence is converted into a vector and provided to the layer. The vector may be called a token, for example. The method comprises (b) dividing the input into N blocks (X₀, X₁, etc.). Each of the N blocks comprises a sequence length that is shorter than the input sequence length. The method comprises (c) determining an initial key (K₀), query (Q₀), and value (V₀) of a first (X₀) of the N blocks, (d) determining an initial key (K₁), query (Q₁) and value (V₁) of a next (X₁) of the N blocks; (e) determining a first block output (\hat{X}₀) for the first (X₀) of the N blocks based on the initial key (K₀), query (Q₀), and value (V₀) of the first (X₀) of the N blocks; and (f) providing the first block output (\hat{X}₀) as input for determining a next block output (\hat{X}₁) for the next (X₁) of the N blocks. The next block output (\hat{X}₁) is determined based on the first block output (\hat{X}₀), and the next (X₁) of the N blocks (though K₁, Q₁, and V₁ can be dependent on \hat{X}₀ and X₁). Operations (a)-(f) facilitate training the neural network with a longer sequence length compared to training of prior neural networks, by dividing the sequence length into smaller blocks to mitigate computational complexity, and subsequently merging the smaller blocks to retain long-range context. In some embodiments, the method comprises (e) repeating operations (d)-(f) for each remaining block of the N blocks, such that, for each block (Xᵢ), each next block output (\hat{X}ᵢ) is output from a previous block (Xᵢ₋₁), thus merging smaller blocks to retain long-range context associated with the input.

In some embodiments, the neural network comprises at least a portion of a large language model. In some embodiments, the neural network comprises a transformer module. In some embodiments, the layer of the neural network comprises a multi-head attention layer of the transformer module. The multi-head attention layer may comprises multiple self-attention modules. Each self-attention module may be associated with one of the N blocks. The multiple self-attention modules are configured to operate in parallel.

In some embodiments, determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.

In some embodiments, determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁).

In some embodiments, the N blocks are split into key, query, and/or value using separate linear layers of the neural network.

In some embodiments, the input comprises the sequence length and an embedding size (C).

In some embodiments, operations (a)-(f) reduce K, Q, V multiply and accumulate operations from 3(ξ×C²)+2(ξ²×C) to 3(ξ×C²)+2(ξ²/N×C) and reduce multiply and accumulate operations because of matrix multiplications in “Norm+SoftMax” blocks by a factor of N.

In some embodiments, a block output coming from previous sequence blocks comprises collective information from all previous sequence blocks.

In some embodiments, instead of feeding a sequence of blocks together, to separate self-attention modules, parameters from one self-attention module are shared for all sequence blocks, such that a block output is fed back to a self-attention module as a hidden state for a next sequence block.

In some embodiments, the method comprises providing a memory line. The memory line is configured to ensure sustained influence of one or more initial blocks of the N blocks, and to establish equal importance for each block in a sequence of N blocks. The memory line is configured to assimilate information from a current output through a self-attention module. The information is appended to the input for subsequent blocks (Xi). In some embodiments, the memory line is configured to obtain information from a present self-attention module and subsequently determine which information should be transmitted to a next self-attention module. In some embodiments, the memory line comprises an adaptation of a Long Short-Term Memory (LSTM) neural network, and/or Gated Recurrent Units (GRUs). In some embodiments, a memory line computation is independent of a number of heads in a multi-head attention layer.

Some aspects include a tangible, non-transitory, machine-readable medium storing instructions that when executed by a data processing apparatus cause the data processing apparatus to perform operations including the above-mentioned method(s).

Some aspects include a system, including: one or more processors; and memory storing instructions that when executed by the processors cause the processors to effectuate operations of the above-mentioned method(s).

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates a system that is configured to provide long range attention in a machine learning model for an input comprising any mode of data. The system comprises a processing engine and other components configured for providing this long range attention, and/or otherwise training a neural network of the machine learning model, with a longer data input sequence length compared to prior neural networks.

FIG. 2 illustrates an example transformer module.

FIG. 3 illustrates a typical self-attention layer.

FIG. 4 illustrates re-illustrates a multi-head attention layer of the example transformer module from FIG. 2, but in FIG. 4, the multi-head attention layer comprises multiple self-attention layers or modules configured for training a neural network with a longer sequence length compared to training of prior neural networks.

FIG. 5 illustrates an example extension of long range module attention with four blocks (N=4), compared to two (N=2), as shown in FIG. 4.

FIG. 6 illustrates long range block attention with recurrence.

FIG. 7 illustrates long range block attention with memory (or a memory line).

FIG. 8 illustrates memory (or memory line) comprising an adaptation of a Long Short-Term Memory (LSTM) neural network, and/or Gated Recurrent Units (GRUs), as two possible examples.

FIG. 9 illustrates an image input, that has been divided into 9 blocks, each with a 16 unit sequence length.

FIG. 10 illustrates a baseline example embodiment of a machine learning model.

FIG. 11a illustrates an enhanced machine learning model relative to the model shown in FIG. 10, with various architectural modifications and additions.

FIG. 11b also illustrates the enhanced machine learning model relative to the model shown in FIG. 10, with the various architectural modifications and additions.

FIG. 12 illustrates an image of a plot or graph that may be used as an input to a machine learning model.

FIG. 13 illustrates a machine learning model (e.g., a machine learning model similar to the model shown in FIG. 11) that may be used to process the image in FIG. 12.

FIG. 14 is a diagram that illustrates an exemplary computing system in accordance with embodiments of the present system.

FIG. 15 is a flowchart of a method for training a neural network with a longer sequence length compared to training of prior neural networks.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of large language models (LLM), natural language processing (NLP), and other fields. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

In machine learning there is a concept called “attention”. Usually attention is performed on a very short number of units (see additional description below). The present systems and methods provide attention on a very large number of units-“long range attention”.

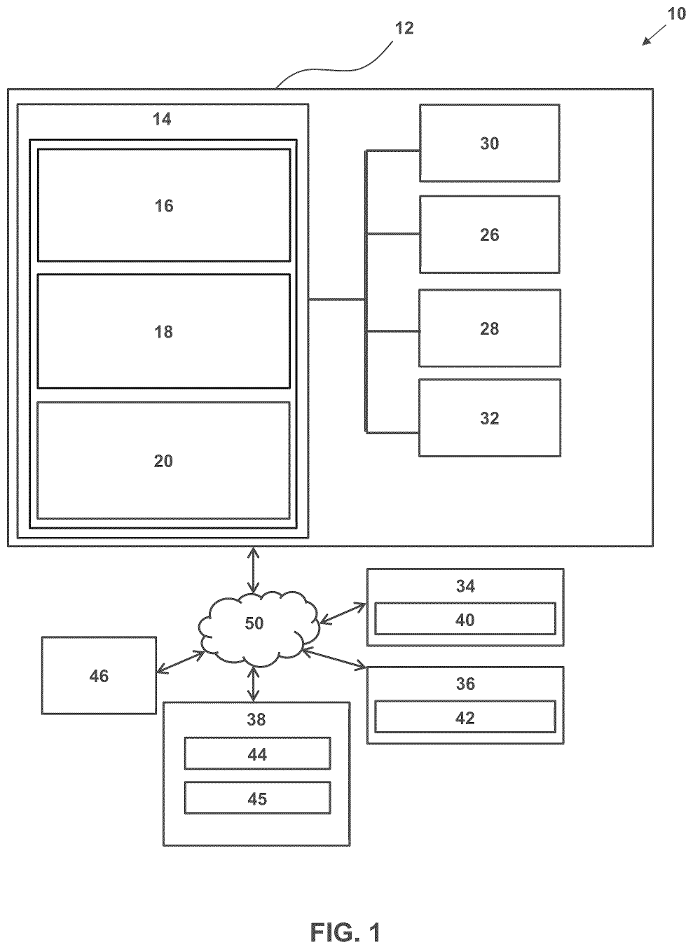

FIG. 1 illustrates a system 10 that is configured to provide long range attention in a machine learning model for an input comprising any mode of data. System 10 comprises a processing engine 12 and other components configured for providing this long range attention, and/or otherwise training a neural network of the machine learning model, with a longer data input sequence length compared to prior neural networks. In some embodiments, the neural network comprises at least a portion of an LLM. In some embodiments, the neural network comprises a transformer module of the LLM, for example. System 10 can be used in algorithm development for vision, language, and/or other related applications that use a transformer as core architecture. Currently, transformers are actively being used as a main building block for large language models (LLMs) such as generative pre-training transformers (GPTs), for example. Because of high computational costs, these models are very expensive to train (i.e., with training costs currently on the order of millions of dollars for each model).

Transformer modules are known for their computational complexity. They excel in comprehending text, images, and/or other inputs. However, their effectiveness is often hindered by hardware limitations when it comes to longer text, image, and/or other input sequences. Increasing an input sequence length leads to a significant increase in computational requirements. In past systems, to accommodate longer input sequences, either a more powerful processing unit was required (e.g., a typical processing unit is a GPU device with large RAM memory, for example a server with 8xA100 NVIDIA GPU cost around 33$ per hour on AWS), or limits were placed on input sequence lengths. However, a shorter sequence length restricts the model's ability to retain older context or information, thereby impacting its overall capability. The number of compute and memory required to train a model increases with sequence length. Currently, typical maximum sequence length is 8k tokens. Usually, a short sequence length is around 256 tokens.

System 10 improves upon prior transformer modules. System 10 provides long range attention in a machine learning model for an input comprising any mode of data, and/or otherwise facilitates training a neural network of the machine learning model, with a longer sequence length compared to training of prior neural networks, by dividing an input sequence length into N smaller blocks to mitigate computational complexity, and subsequently merging the smaller blocks to retain long-range context, as described herein. This significantly reduces the computational complexity of a transformer module, among other advantages. The reduced computational complexity means that system 10 is configured such that more powerful processing units are not required for training a model, and no limits need to be placed on sequence lengths used during training.

These and other benefits are described in greater detail below, after introducing the components of system 10 and describing their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

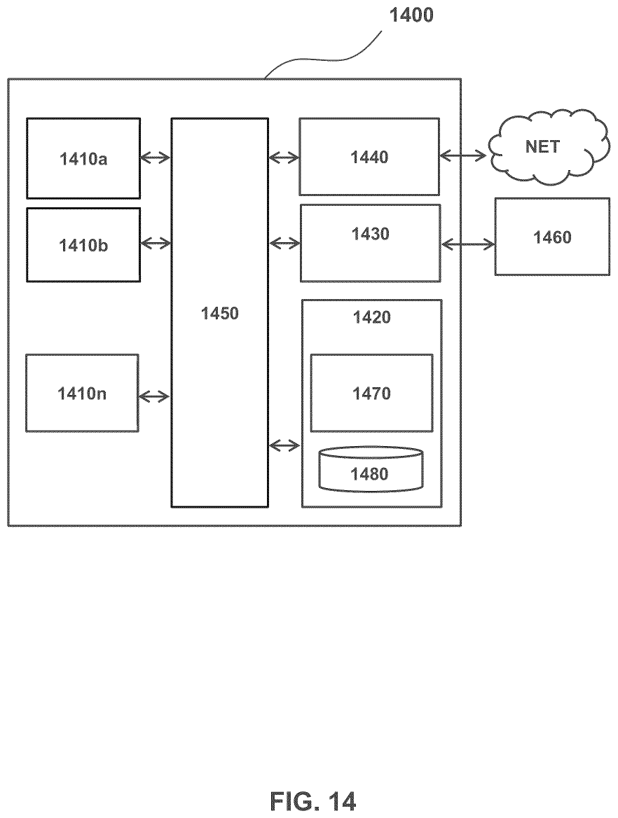

In some embodiments, processing engine 12 is executed by one or more of the computers described below with reference to FIG. 14 and may include one or more of a controller 14, an application program interface (API) server 26, a web server 28, a data store 30, and a cache server 32. These components, in some embodiments, communicate with one another in order to provide the functionality of processing engine 12 described herein.

Cache server 32 may expedite access to relevant data by storing likely relevant data in relatively high-speed memory, for example, in random-access memory or a solid-state drive. Web server 28 may serve webpages having graphical user interfaces that display one or more views that facilitate receiving entry or selection of input from a user (e.g., training input), and/or other views. API server 26 may serve data to various applications that process data related to user requested tasks, or other data. The operation of these components 26, 28, and 30 may be coordinated by controller 14, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users and/or other entities may occur via a website or a native application viewed on a desktop computer, tablet, or a laptop of the user. In some embodiments, such interaction occurs via a mobile website viewed on a smart phone, tablet, or other mobile user device, or via a special-purpose native application executing on a smart phone, tablet, or other mobile user device. Data may be extracted by controller 14 and/or other components of system 10 from data store 30 and/or other sources inside or outside system 10. Data extraction by controller 14 may be configured to be sufficient for system 10 to function as described herein, without compromising privacy and/or other requirements associated with a data source.

To illustrate an example of the environment in which processing engine 12 operates, the illustrated embodiment of FIG. 1 includes a number of components with which processing engine 12 communicates: mobile user devices 34 and 36; a desk-top user device 38; and external resources 46. Each of these devices communicates with processing engine 12 via a network 50, such as the Internet or the Internet in combination with various other networks, like local area networks, cellular networks, Wi-Fi networks, or personal area networks.

Mobile user devices 34 and 36 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user devices 34 and 36 may store instructions that when executed by the associated processor provide an operating system and various applications, including a web browser 42 and/or a native mobile application 40. The desktop user device 38 may also include a web browser 44 a native application 45, and/or other electronic resources. In addition, desktop user device 38 may include a monitor; a keyboard; a mouse; memory; a processor; and a tangible, non-transitory, machine-readable memory storing instructions that when executed by the processor provide an operating system and the web browser 44 and/or the native application 45.

Native applications and web browsers 40, 42, 44, and 45, in some embodiments, are operative to provide a graphical user interface associated with a user, for example, that communicates with processing engine 12 and facilitates user interaction with data provided to and/or received from processing engine 12. In some embodiments, processing engine 12 may be stored on and/or otherwise be executed user computing resources (e.g., a user computer, server, etc., such as mobile user devices 34 and 36, and desktop user device 38 associated with a user), servers external to the user, and/or in other locations. In some embodiments, processing engine 12 may be run as an application (e.g., an app such as native application 40) on a server, a user computer, and/or other devices.

Web browsers 42 and 44 may be configured to receive a website from processing engine 12 having data related to instructions (for example, instructions expressed in JavaScript™) that when executed by the browser (which is executed by the processor) cause mobile user device 36 and/or desktop user device 38 to communicate with processing engine 12 and facilitate user interaction with data provided to and/or received from processing engine 12. Native application 40 and 45, and web browsers 42 and 44, upon rendering a webpage and/or a graphical user interface from processing engine 12, may generally be referred to as client applications of processing engine 12, which in some embodiments may be referred to as a server. Embodiments, however, are not limited to client/server architectures, and processing engine 12, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, and/or multiple countries across the world.

External resources 46, in some embodiments, include sources of information such as databases, websites, etc.; external entities participating with the system 10, one or more servers outside of the system 10, a network (e.g., the internet), electronic storage, equipment related to Wi-Fi™ technology, equipment related to Bluetooth® technology, data entry devices, or other resources. In some implementations, some or all of the functionality attributed herein to external resources 46 may be provided by resources included in system 10. External resources 46 may be configured to communicate with processing engine 12, mobile user devices 34 and 36, desktop user device 38, and/or other components of the system 10 via wired and/or wireless connections, via a network (e.g., a local area network and/or the internet), via cellular technology, via Wi-Fi technology, and/or via other resources.

Thus, processing engine 12, in some embodiments, operates in the illustrated environment by communicating with a number of different devices and transmitting instructions to various devices to communicate with one another. The number of illustrated external resources 46, desktop user devices 38, and mobile user devices 36 and 34 is selected for explanatory purposes only, and embodiments are not limited to the specific number of any such devices illustrated by FIG. 1, which is not to imply that other descriptions are limiting.

Processing engine 12 may include a number of components introduced above that facilitate training a neural network with a longer sequence length compared to training of prior neural networks. For example, the illustrated API server 26 may be configured to communicate user input (e.g., training input) text commands, input images, input numerical data, an input audio recording, input radar data, an input spectrogram, and/or (any) other modes of input data, and/or other information via a protocol, such as a representational-state-transfer (REST)-based API protocol over hypertext transfer protocol (HTTP) or other protocols. Examples of operations that may be facilitated by the API server 26 include requests to train a neural network based on a provided input sequence (as described herein), and/or other information. API requests may identify which output data is to be displayed linked, modified, added, or retrieved by specifying criteria for identifying tasks. In some embodiments, the API server 26 communicates with the native application 40 of the mobile user device 34, the native application 45 of the desktop user device 38, and/or other components of system 10.

The illustrated web server 28 may be configured to provide, display, link, modify, add, or retrieve portions or all of a user's training sequence input, a response to user prompt, and/or other information encoded in a webpage (e.g. a collection of resources to be rendered by the browser and associated plug-ins, including execution of scripts, such as JavaScript™, invoked by the webpage). In some embodiments, the graphical user interface presented by the webpage may include inputs by which the user may enter or select data, such as clickable or touchable display regions or display regions for text input. For example, a training input sequence comprising one or more images may be uploaded, in combination with one or more entered textual characters. Such inputs may prompt the browser to request additional data from the web server 28 or transmit data to the web server 28, and the web server 28 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 28 may communicate with web browsers, such as the web browser 42 or 44 executed by user devices 36 or 38. In some embodiments, the webpage is modified by the web server 28 based on the type of user device, e.g., with a mobile webpage having fewer and smaller images and a narrower width being presented to the mobile user device 36, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and the web server 28 may select the appropriate interface based on this embedded identifier, thereby providing an interface appropriately configured for the specific user device in use.

The illustrated data store 30, in some embodiments, stores and/or is configured to access data required for training a neural network with a longer sequence length compared to training of prior neural networks, and/or other information. Data store 30 may include various types of data stores, including relational or non-relational databases; image, document, audio, radar, spectrogram, etc., collections; and/or programming instructions related to training, storage, and/or execution of one or more of the models described herein, for example. Such components may be formed in a single database, or may be stored in separate data structures. In some embodiments, data store 30 comprises electronic storage media that electronically stores information. The electronic storage media of data store 30 may include one or both of system storage that is provided integrally (i.e., substantially non-removable) with system 10 and/or other storage that is connectable (wirelessly or via a wired connection) to system 10 via, for example, a port (e.g., a USB port, a firewire port, etc.), a drive (e.g., a disk drive, etc.), a network (e.g., the Internet, etc.). Data store 30 may be (in whole or in part) a separate component within system 10, or data store 30 may be provided (in whole or in part) integrally with one or more other components of system 10 (e.g., controller 14, external resources 46, etc.). In some embodiments, data store 30 may be located in a data center, in a server that is part of external resources 46, in a computing device 34, 36, or 38, and/or in other locations. Data store 30 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 30 may store software algorithms, information determined by controller 14, information received via the graphical user interface displayed on computing devices 34, 36, and/or 38, information received from external resources 46, or other information accessed by system 10 to function as described herein.

Controller 14 is configured to coordinate the operation of the other components of processing engine 12 to provide the functionality described herein. Controller 14 may be formed by one or more processors, for example. Controlled components may include one or more of an input component 16, a determination component 18, an output component 20, and/or other components. Controller 14 may be configured to direct the operation of components 16, 18, and/or 20 by software; hardware; firmware; some combination of software, hardware, or firmware; or other mechanisms for configuring processing capabilities.

It should be appreciated that although components 16, 18, and 20 are illustrated in FIG. 1 as being co-located, one or more of components 16, 18, and/or 20 may be located remotely from the other components. The description of the functionality provided by the different components 16, 18, and/or 20 described below is for illustrative purposes, and is not intended to be limiting, as any of the components 16, 18, and/or 20 may provide more or less functionality than is described, which is not to imply that other descriptions are limiting. For example, one or more of components 16, 18, and/or 20 may be eliminated, and some or all of its functionality may be provided by others of the components 16, 18, and/or 20, again which is not to imply that other descriptions are limiting. As another example, controller 14 may be configured to control one or more additional components that may perform some or all of the functionality attributed below to one of the components 16, 18, and/or 20. In some embodiments, processing engine 12 (e.g., controller 14 in addition to cache server 32, web server 28, and/or API server 26) is executed in a single computing device, or in a plurality of computing devices in a datacenter, e.g., in a service oriented or micro-services architecture.

In some embodiments, processing engine 12 may be configured such that the operations of controller 14, and input from users and/or sources of information inside or outside system 10, may be processed by controller 14 through a variety of formats, including clicks, touches, uploads, downloads, etc. The illustrated components (e.g., controller 14, API server 26, web server 28, data store 30, and cache server 32) of processing engine 12 are depicted as discrete functional blocks, but embodiments are not limited to systems in which the functionality described herein is organized as illustrated by FIG. 1. The functionality provided by each of the components of processing engine 12 may be provided by software or hardware modules that are differently organized than is presently depicted, for example such software or hardware may be intermingled, broken up, distributed (e.g. within a data center or geographically), or otherwise differently organized. The functionality described herein may be provided by one or more processors of one or more computers executing code stored on a tangible, non-transitory, machine readable medium.

As described above, processing engine 12 of system 10 is configured for providing long range attention in a machine learning model for an input comprising any mode of data, and/or otherwise training a neural network of the machine learning model, with a longer sequence length compared to training of prior neural networks. In some embodiments, training configures the neural network to learn to predict a certain output, given a certain input. Once trained, the neural network may be deployed to output responses to new user prompts (e.g., inputs). In some embodiments, the neural network comprises at least a portion of a large language model (LLM). For example, the neural network may comprise a transformer module of the LLM. In some embodiments, the transformer module comprises a stack of transformer layers. The layers may include a multi-head attention layer, a normalization layer, a feed-forward layer, and an additional normalization layer, for example.

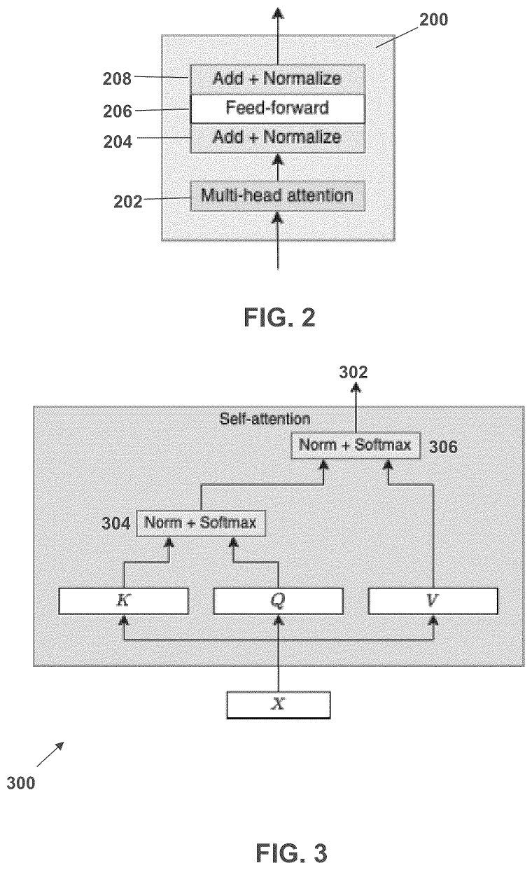

For example, FIG. 2 illustrates an example transformer module 200. A neural network can be built using a stack of transformer modules 200. A transformer module may include layers and/or other components. The layers may include a multi-head attention layer 202, a normalization layer 204, a feed-forward layer 206, and an additional normalization layer 208. In some embodiments, a neural network such as transformer module 200 also comprises encoder decoder architecture. Encoder decoder architecture has an encoding portion (an encoder) and a decoding portion (a decoder). The encoder is configured to encode an input into a low dimensional encoding or embedding space. In some embodiments, the low dimensional embedding represents one or more features of an input. The one or more features of the input may be considered key or critical features of the input. Features may be considered key or critical features of an input because they are relatively more predictive than other features of a desired output and/or have other characteristics, for example. The one or more features (dimensions) represented in the low dimensional embedding may be predetermined (e.g., by a programmer at the creation of the present modular autoencoder model), determined and/or otherwise learned by prior layers of a neural network, adjusted by a user via a user interface associated with a system described herein, and/or may be determined in by other methods. In some embodiments, a quantity of features (dimensions) represented by the low dimensional embedding may be predetermined (e.g., by the programmer at the creation of the present modular autoencoder model), determined based on output from prior layers of the neural network, adjusted by the user via the user interface associated with a system described herein, and/or determined by other methods.

Neural networks such as transformer module 200 may be based on a large collection of neural units (or artificial neurons). Neural networks may loosely mimic the manner in which a biological brain works (e.g., via large clusters of biological neurons connected by axons). Each neural unit of a neural network may be simulated as being connected with many other neural units of the neural network. Such connections can be enforcing or inhibitory in their effect on the activation state of connected neural units. In some embodiments, each individual neural unit may have a summation function which combines the values of all its inputs together. In some embodiments, each connection (or the neural unit itself) may have a threshold function such that the signal must surpass the threshold before it is allowed to propagate to other neural units. These neural network systems may be self-learning and trained, rather than explicitly programmed, and can perform significantly better in certain areas of problem solving, as compared to traditional computer programs. In some embodiments, neural networks may include multiple layers (e.g., where a signal path traverses from front layers to back layers). In some embodiments, back propagation techniques may be utilized by the neural networks, where forward stimulation is used to reset weights on the “front” neural units. In some embodiments, stimulation and inhibition for neural networks may be more free flowing, with connections interacting in a more chaotic and complex fashion.

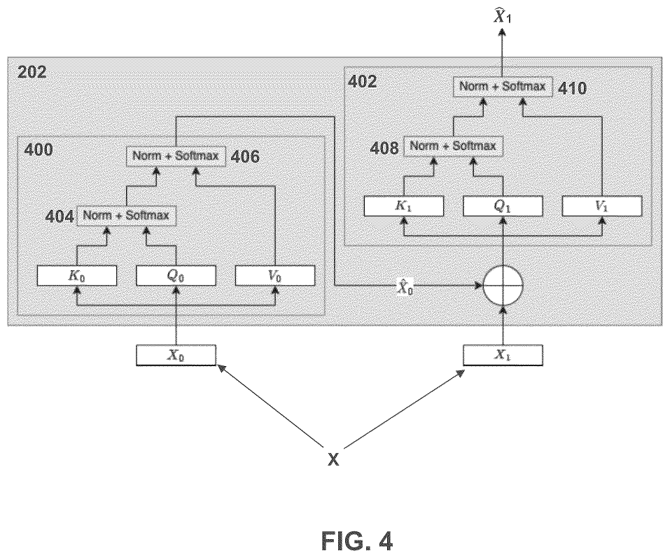

Multi-head attention layer (e.g., layer 202) may comprise multiple self-attention layers that operate in parallel. A typical self-attention layer 300 is shown in FIG. 3. As shown in FIG. 3, an input (or input token) X is split into K (key), Q (query), and V (value) components using separate linear layers. The input X comprises a sequence having an input sequence length (g), an embedding size (C), and/or other characteristics. The sequence may comprise characters, words, phrases, image pixels, an audio recording, radar data, a spectrogram, data bytes, and/or other units. Each unit of a sequence is converted into a vector and provided to the layer. The vector may be called a token, for example. An output 302 from layer 300 may be determined based on the key, query, and value components. Output 302 may be determined by performing a first Norm+Softmax operation 304 using the key and query, and then performing a second Norm+Softmax operation 306 using output from the first Norm+Softmax operation 304 and the value component. Output 302 may usually be provided to the feedforward layer (206), because the attention is used to create learnable features. The added non-linearity (feedforward layer in 206) provides a better projection matrix with normalization before the output of one multi-head attention block can be sent to the next multi-head attention block. A neural network utilizing transformer module 200 (FIG. 2) and/or self-attention layer(s) 300 (FIG. 3) can make decisions based on the sequence of the input tokens it receives.

However, as the sequence length (ξ) increases, so does the computational complexity and memory requirements of transformer module 200. This often requires a trade-off between the sequence length and the depth of a neural network (e.g., the number of stacked transformer modules) that can be executed on a given hardware configuration. In addition, extended input training sequence lengths are often necessary if a neural network is to be configured to grasp longer contextual dependencies. For example, in the training of a large language model (LLM) to comprehend a document comprising multiple chapters, a neural network may require training input information from chapter one of the document while processing sections in chapter ten, for example. If only a shorter sequence length may be utilized (e.g., because of system limitations and/or for other reasons), training may only be able to encompass input from a single, immediately previous chapter. Consequently, the neural network, in this example, would only be able to reference chapter nine while processing chapter ten.

Returning to FIG. 1, system 10, in contrast to prior systems, provides long range attention in a machine learning model for an input comprising any mode of data, and/or otherwise facilitates training a neural network of the machine learning model, with a longer sequence length compared to training of prior neural networks, by dividing an input sequence length into N smaller blocks to mitigate computational complexity, and subsequently merging the smaller blocks to retain long-range context. For example, input component 16 of processing engine 12 is configured to receive an input (X) (e.g., a training input) with a layer of a neural network. The input comprises a sequence having an input sequence length (ξ), an embedding size (C), and/or other characteristics. The sequence length may be relatively long (e.g., above 16k units), for example. The sequence may comprise characters, words, phrases, image pixels, an audio recording, radar data, a spectrogram, data bytes, and/or other units. Each unit of a sequence is converted into a vector by input component 16 and provided to the layer. The vector may be called a token, for example. As described related to FIG. 2, the neural network may comprise a transformer module (e.g., the same as or similar to module 200 described above) and/or other components of a large language model, for example. The layer of the neural network may be a multi-head attention layer of the transformer module (e.g., similar to and/or the same as layer 202 shown in FIG. 2).

Input component 16 is configured to divide the input (X) into N blocks (X₀, X₁, etc.), with each of the N blocks comprising a sequence length that is shorter than the input sequence length (e.g., about 1024 units). In some embodiments, the multi-head attention layer (e.g., layer 202) described above comprises multiple self-attention modules, each self-attention module associated with one of the N blocks. These multiple self-attention modules are configured to operate in parallel and/or may have other configurations.

Determination component 18 is configured to determine a key (K), query (Q), value (V), and/or other information for each of the N blocks. This includes a key (K₀), query (Q₀), and value (V₀) of a first (X₀) of the N blocks, and a key (K₁), query (Q₁) and value (V₁) of a next (X₁) of the N blocks, for example. In some embodiments, the N blocks are split into key, query, and/or value using separate linear layers of the neural network.

Output component 20 is configured to determine a first block output (\hat{X}₀) for the first (X₀) of the N blocks based on the key (K₀), query (Q₀), and value (V₀) of the first (X₀) of the N blocks. In some embodiments, determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks, and/or other operations. Output component 20 is configured to provide the first block output (\hat{X}₀) as input for determining a next block output (\hat{X}₁) for the next (X₁) of the N blocks. Providing the first block output as input for determining a next block output may comprise adding, combining, averaging inputting side by side, concatenation, aggregation, and/or other providing. The next block output (\hat{X}₁) is determined based on the first block output (\hat{X}₀), and the key (K₁), query (Q₁), and value (V₁) of the next (X₁) of the N blocks, and/or other information. For example, in some embodiments, determining a next block output (\hat{X}ᵢ) for a next (\hat{X}ᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁). Norm and Softmax is used to normalize vectors and convert them into probabilities. This has the effect of highlighting the most relevant features. Others have tried to use different operations such as Sigmoid, but they failed to produce good results because alternate operations do not create probability distributions.

These operations may be repeated for each remaining block of the N blocks, such that, for each block (Xᵢ), each next block output (\hat{X}ᵢ) is determined based on output from a previous block (\hat{X}ᵢ₋₁), thus merging smaller blocks to retain long-range context associated with the input. A block output coming from previous sequence blocks comprises collective information from all previous sequence blocks. In this way, system 10 provides long range attention in a machine learning model for an input comprising any mode of data, and/or otherwise facilitates training a neural network of the machine learning model, with a longer sequence length compared to training of prior neural networks, by dividing an input sequence length into N smaller blocks to mitigate computational complexity, and subsequently merging the smaller blocks to retain long-range context.

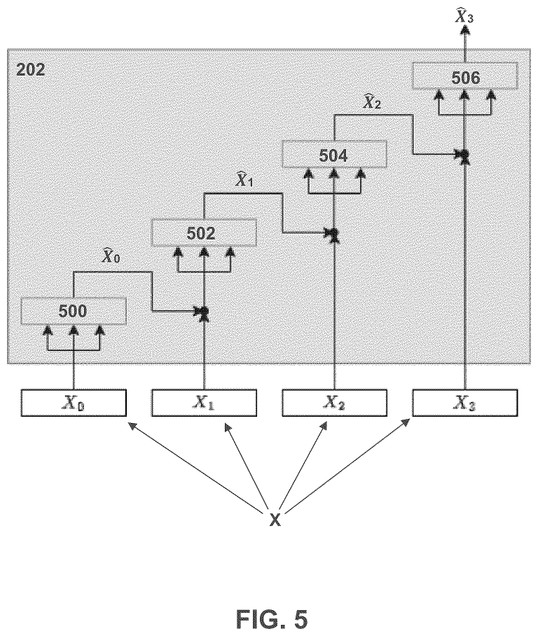

By way of a non-limiting example, FIG. 4 illustrates re-illustrates multi-head attention layer 202 from FIG. 2. But in FIG. 4, multi-head attention layer 202 comprises multiple self-attention layers or modules (layers or modules 400 and 402 in this example) configured for training a neural network with a longer sequence length compared to training of prior neural networks. An input (X) (e.g., a training input) is received (e.g., by input component 16 of processing engine 12 shown in FIG. 1). The input (X) is divided into N blocks (X₀, and X₁ in this example), with each of the N blocks comprising a sequence length that is shorter than the input sequence length. Multi-head attention layer 202 comprises multiple self-attention modules 400 and 402, which are each associated with one of the N blocks (e.g., X₀ and X₁ respectively). A key (K), query (Q), and value (V) are determined (e.g., by determination component 18 shown in FIG. 1) for each of the N blocks. This includes a key (K₀), query (Q₀), and value (V₀) of a first (X₀) of the N blocks, and a key (K₁), query (Q₁) and value (V₁) of a next (X₁) of the N blocks, for example.

A first block output (\hat{X}₀) is determined (e.g., by output component 20 shown in FIG. 1) for the first (X₀) of the N blocks based on the key (K₀), query (Q₀), and value (V₀) of the first (X₀) of the N blocks. In some embodiments, determining the first block output (\hat{X}₀) for the first (X₀) of the N blocks comprises performing a first Norm+Softmax operation 404 using the initial key (K₀) and query (Q₀), and then performing a second Norm+Softmax operation 406 using output from the first Norm+Softmax operation and the initial value (V₀) of the first (X₀) of the N blocks. Output component 20 (FIG. 1) is configured to provide the first block output (X₀) as input for determining a next block output (\hat{X}₁) for the next (X₁) of the N blocks. The next block output (\hat{X}₁) is determined based on the first block output (\hat{X}₀), and the key (K₁), query (Q₁), and value (V₁) of the next (X₁) of the N blocks. For example, in some embodiments, determining the next block output (\hat{X}₁) for the next (X₁) of the N blocks, comprises performing a first Norm+Softmax operation 408 using a key (K₁) for the next block and a query (Q₁) for the next block, and output from the previous block (X₀); and then performing a second Norm+Softmax operation 410 using output from the first Norm+Softmax operation 408, a value (V₁) of the next (X₁) of the N blocks, and the output from the previous block (\hat{X}₀).

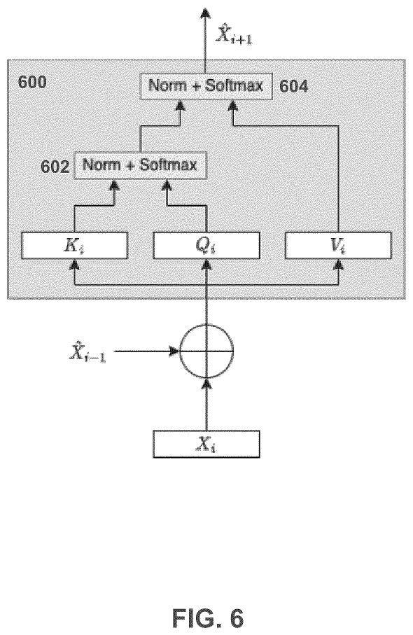

As another example, FIG. 5 illustrates an example extension of long range module attention with four blocks (N=4), compared to two (N=2) as shown in FIG. 4. The same principles apply. In FIG. 5, multi-head attention layer 202 comprises multiple self-attention layers or modules (layers or modules 500, 502, 504, and 506 in this example) configured for training a neural network with a longer sequence length compared to training of prior neural networks. Input (X) (e.g., a training input) is received (e.g., by input component 16 of processing engine 12 shown in FIG. 1). The input (X) is divided into N blocks (X₀, X₁ X₂, and X₃ in this example), with each of the N blocks comprising a sequence length that is shorter than the input sequence length. Multi-head attention layer 202 comprises multiple self-attention modules 500-506, which are each associated with one of the N blocks (e.g., X₀, X₁ X₂, and X₃ respectively). A key (K), query (Q), and value (V) are determined (e.g., by determination component 18 shown in FIG. 1) for each of the N blocks. In some embodiments, determining a next block output [\hat{X}ᵢ] for a next [Xᵢ] of the N blocks, comprises performing a first Norm+Softmax operation using a key [Kᵢ] for the next block and a query [Qᵢ] for the next block, and output from a previous block [Xᵢ₋₁]; and then performing a second Norm+Softmax operation using output from the first Norm+Softmax operation, a value [Vᵢ] of the next [Xᵢ] of the N blocks, and the output from the previous block [Xᵢ₋₁]. These operations may be repeated for each remaining block of the N blocks, such that, for each block (Xᵢ), each next block output (\hat{X}ᵢ) is determined based on output from a previous block (\hat{X}ᵢ₋₁), thus merging smaller blocks to retain long-range context associated with the input. A block output coming from previous sequence blocks comprises collective information from all previous sequence blocks.

As a practical comparison of the computational complexity associated with system 10 and prior systems, assuming a single head transformer and an input batch size of one, a computational matrix shape of key, query, and value related computations is: ξ×C. In prior systems, a number of computational operations (e.g., MACs: multiply and accumulate operations) for each K, Q, V operation=ξ×C², and the matrix multiplication between Q×K^{T} (with the exponential T indicating a transposed matrix) and the result of the first “Norm+SoftMax” and V operation (e.g., as shown in FIG. 3) is ξ²×C. A total number of computational operations (e.g., MACs) for self-attention layer 300 (e.g., as may be found in a prior system) is given by Equation 1:

$${Ops}_{SA} = 3 ( ξ \times {C}^{2} ) + 2 ( {ξ}^{2} \times C ) . \qquad ( 1 )$$

System 10 (FIG. 1) provides a modified self-attention module (e.g., multiple self-attention layers or modules 400 and 402 shown in FIG. 4) such that a given neural network (e.g., transformer model) can handle a longer sequence length. Instead of one input XϵR^{ξ×C}, an input X (e.g., a training input sequence) is received (e.g., by input component 16 of processing engine 12 shown in FIG. 1), and divided into N blocks (X₀, X₁, . . . . Xᵢ), with each of the N blocks comprising a sequence length that is shorter than the input sequence length. As a result, computational operations (e.g., the MAC's) associated with Kᵢ, Qᵢ, and Vᵢ of the i^{th} block become (ξ/N)×C². The operations for matrix multiplication for the i^{th} block=(ξ/N)²×C. Output from a previous block (\hat{X}ᵢ₋₁) is combined with a current input block (Xᵢ). The combination can be in the form of addition or concatenation of two vectors, and/or other combinations. This ensures that the context from previous block is carried to the current block self-attention module, allowing the neural network to learn richer features. Thus, the total number of computational operations (e.g., MAC's) for long range block attention (LRBA) system 10 are given by Equation 2:

$${Ops}_{LRBA} = 3 N \times ( ξ / N ) \times {C}^{2} + 2 N \times {( ξ / N )}^{2} \times C \\ which equals \\ 3 ( ξ \times {C}^{2} ) + 2 ( ( {ξ}^{2} / N ) \times C ) . \qquad ( 2 )$$

In other words, use of system 10 may reduce K, Q, V multiply and accumulate operations (e.g., MAC's) from 3(ξ×C²)+2(ξ²×C) to 3(ξ×C²)+2(ξ²/N×C), and reduce multiply and accumulate operations because of matrix multiplications in “Norm+SoftMax” blocks by a factor of N, among other advantageous effects.

This architecture in system 10 (compared to prior systems) significantly reduces the number of computational operations (e.g., the MAC's) because matrix multiplications in a “Norm+SoftMax” block are reduced by a factor of N. This reduction provides long range attention in the machine learning model for an input comprising any mode of data, and/or otherwise facilitates training the neural network of the machine learning model with longer training input sequence lengths. The output from a previous block (\hat{X}ᵢ₋₁) includes collective information from each previous block. Referring to the chapter example above, the hardware and/or processing power associated with a given system is no longer a limitation. With system 10, a number blocks, N, may be large enough such that training can encompass information from chapter 1, which is fed through the various blocks described above as necessary for eventually processing chapter 10.

In some embodiments, instead of feeding a sequence of blocks together, to separate self-attention modules, system 10 is configured such that parameters from one self-attention module recur, or are shared for all sequence blocks, such that a block output is fed back to a self-attention module as a hidden state for a next sequence block. These embodiments have the same reduced computational complexity described above, and also have the added benefit of a reduced memory footprint, by a factor of N. Instead of feeding all sequence blocks together, to separate self-attention blocks, one self-attention module is used, and its parameters are shared for all sequence blocks. An output (\hat{X}ᵢ₋₁) may be fed back to a self-attention module as a hidden state for the next sequence block.

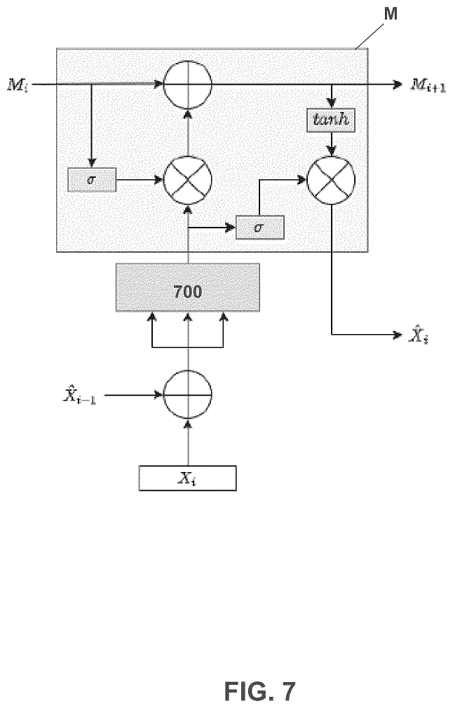

For example, FIG. 6 illustrates long range block attention with recurrence. In FIG. 6, multi-head attention layer 202 (FIG. 2) comprises a multiple self-attention layer or module (layer or module 600 in this example) configured for training a neural network with a longer sequence length compared to training of prior neural networks. A block output (\hat{X}ᵢ+1) is determined (e.g., by output component 20 shown in FIG. 1) for the i^{th} (Xᵢ) of the N blocks based on the key (Kᵢ), query (Qᵢ), and value (Vᵢ) of the i^{th} (Xᵢ) of N blocks, along with output (\hat{X}ᵢ₋₁) from a previous block (Xᵢ₋₁). In some embodiments, determining the block output (\hat{X}ᵢ₊₁) again comprises performing a first Norm+Softmax operation 602 using the key (Kᵢ) and query (Qᵢ), and then performing a second Norm+Softmax operation 604 using output from the first Norm+Softmax operation 602 and the value (Vᵢ) of the i^{th} (Xᵢ) of the N blocks. Note that in FIGS. 4 and 6 the flow of data is the same. However, in FIG. 4, there are two blocks and parameters of K, Q, V, and each block is different. Weights are learnable parameters that after converging for a dataset, will produce features. Attention is a score of how important each Q unit is in relation to each K unit in the sequence. Then this score is combined with the unit value V, which contains the information of the sequence units. In FIG. 4, KQV do not share the same parameters. In FIG. 6 and as explained above, weights/parameters/filters are shared. Filters learned in K are reused in the calculation of K2; filters used to calculate Q1 will be also used to calculate Q2, etc. Whereas, in FIG. 6, all blocks share the same weight(s). In this example, if the module shown in FIG. 4 had, for example, 10 million parameters and 40 megabytes of data that needed to be stored in memory, and the number of blocks is two as shown, the module in FIG. 6 will consume, for only 5 million parameters, 20 megabytes of memory.

Returning to FIG. 1, in some embodiments, one or more of components 16-18 may provide memory, or a memory line. The memory line is configured to ensure sustained influence of one or more initial blocks of the N blocks, and to establish equal importance for each block in a sequence of N blocks. In some embodiments, the memory line is configured to assimilate information from a current output through a self-attention module. Using the memory line, information is appended to the input of subsequent blocks (Xᵢ). In some embodiments, the memory line is configured to obtain information from a present self-attention module and subsequently determine which information should be transmitted to a next self-attention module. In some embodiments, the memory line comprises an adaptation of a Long Short-Term Memory (LSTM) neural network, and/or Gated Recurrent Units (GRUs), as two possible examples. In some embodiments, a computation associated with the memory line is independent of a number of heads in a multi-head attention layer. Note that the term “line” is used merely as a conceptual reference to aid the reader's understanding of the present concepts. This feature need not form any sort of actual “line” to function as described herein.

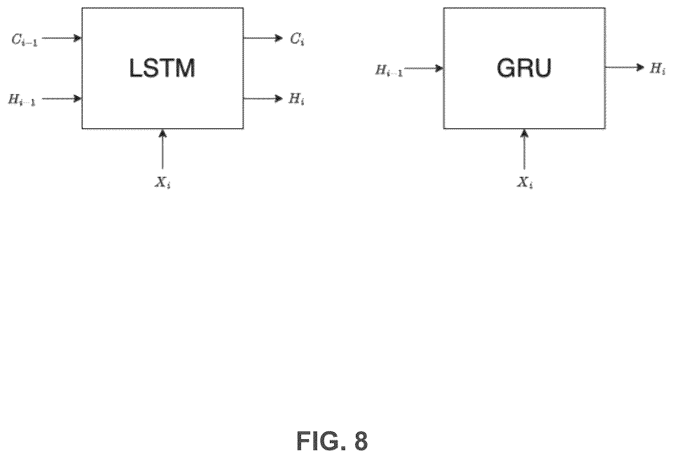

By way of a non-limiting example, FIG. 7 illustrates long range block attention with memory (or a memory line) M. In FIG. 7, multi-head attention layer 202 (FIG. 2) comprises memory M and a multiple self-attention layer or module 700 (which is similar to and/or the same as one or more of the self-attention layers or modules described above). When a large number of blocks (N) are utilized, a resulting output (\hat{X}ᵢ) may exhibit a stronger inclination towards a final block, Xₗₐₛₜ, in comparison to the initial block, X₀. Memory (or memory line) M may be used to ensure the sustained influence of the initial block(s), and/or to establish equal importance for each block (Xᵢ) in a sequence on corresponding outputs (\hat{X}ᵢ). In FIG. 7, Mᵢ represents an output and/or other data associated with one or more previous blocks, and Mᵢ₊₁ represents an output and/or other data that may be provided to one or more future blocks. Memory M is configured to assimilate information from a current output through the self-attention module. This acquired information is then appended to Xᵢ of subsequent blocks. In this example, σ and tanh represent sigmoid and arc tan/inverse tan/hyperbolic tangent function non-linear functions.

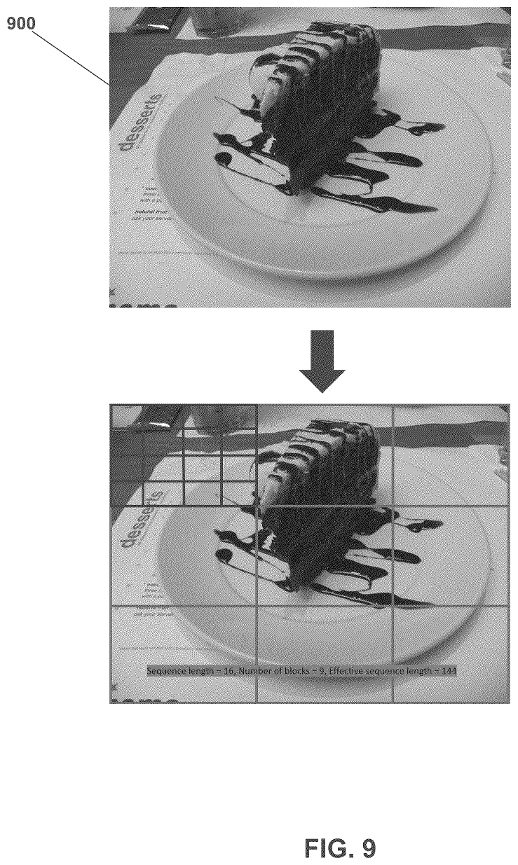

FIG. 8 illustrates memory (or memory line) M comprising an adaptation of a Long Short-Term Memory (LSTM) neural network, and/or Gated Recurrent Units (GRUs), as two possible examples. As shown in FIG. 8, X₁ from a conventional LSTM/GRU block is replaced by the output of each sequence block. Here H is the recurring output of the LSTM/GRU block. In LSTM, C is an internal memory cell also known as cell state and H is called hidden state, from an LSTM block correspond to Mᵢ₊₁ and \hat{X}ᵢ, respectively. For a GRU block, Hᵢ represents \hat{X}ᵢ, and there is no Mᵢ₊₁.

The inclusion of memory (or memory line) M may introduce additional computations amounting to 3(ξ×C²). This computational load may be higher if GRU and/or LSTM units are used. However, this increased computational load is still lower than the computational load associated with the self-attention module shown in FIG. 1 (and described in Eq. (1) above). For example, the cumulative computations for these embodiments of long range block attention (LRBA) system 10 can be summarized by Equation 3:

$${Ops}_{LRBA mem} = 6 ( ξ \times {C}^{2} ) + 2 ( ( {ξ}^{2} / N ) \times C ) . \qquad ( 3 )$$

As one practical representative example, ξ may be greater than about 4096 and C may be approximately 756. Therefore, for N>1 Ops_{LRBA mem} (Eq. 3) is less than Ops_{SA} (Eq. 1).

Once trained, the neural network may be deployed to output responses to new user prompts (e.g., inputs). In some embodiments, deployment and/or use of the trained neural network may also be considered a part of the systems and methods described herein, for example.

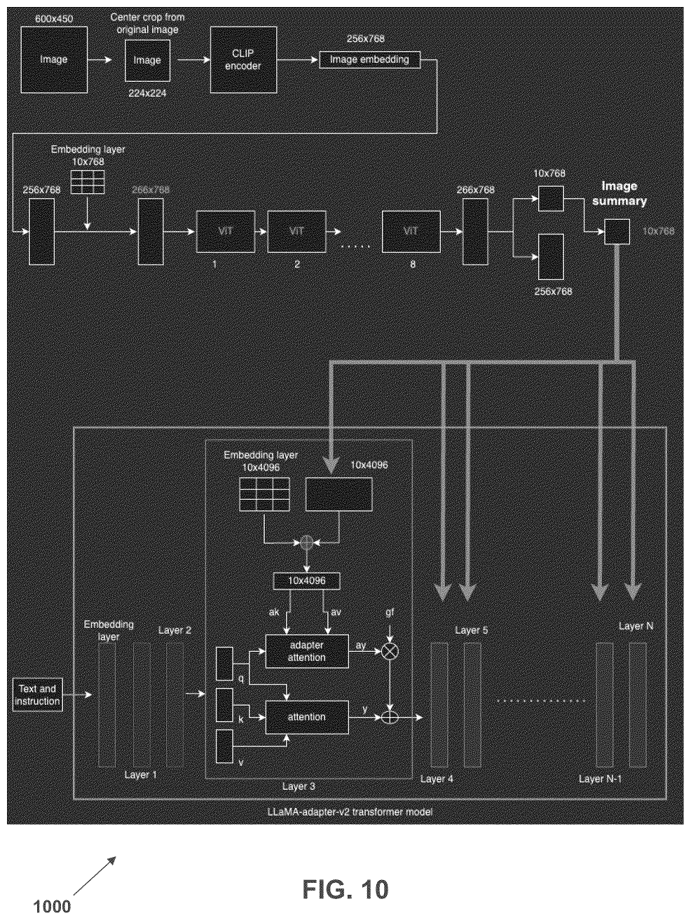

FIG. 9-FIG. 13 illustrate additional practical examples of the concepts described herein, using image based input data (which is just one possibility of many potential modes of input data, as described above).

FIG. 9 illustrates an image 900 input, that has been divided into nine blocks, each with a 16 unit sequence length (for an effective total sequence length of 144, instead of some more limited sequence length maximum (e.g., 50 units total) that could be provided to a prior model if image 900 was not divided into blocks). The images in documents such as image 900, and also plots and graphs (as described in another example below), are often high resolution images (example: 1100×700). Resizing these images can lead to critical information loss. The current state of the are machine learning models can only usually process small images sizes (example: 224×224 or 336×336). Also, processing high resolution images such as image 900 is computationally expensive with current state of the art machine learning models. The systems and methods described herein address this issue by providing a mechanism to process high resolution images without information loss. Also, the computational cost of the machine learning model(s) described herein is similar to prior models.

In this example, the present system(s) and method(s) are configured for taking high-resolution image 900, breaking it down into multiple crops or blocks, then processing the crops or blocks sequentially one by one as described above by concatenating them with a learnable embedding (vectors). After processing each crop using vision transformer layer, for example, the learned summary of a crop is added or concatenated to the next crop (e.g., the output from a prior block is provided as input to a next block). This is repeated until a summary output can be provided to a large language model for learning, generating text, and/or for other purposes. This allows machine learning models such as those described herein to process and learn high resolution images with low computational complexity.

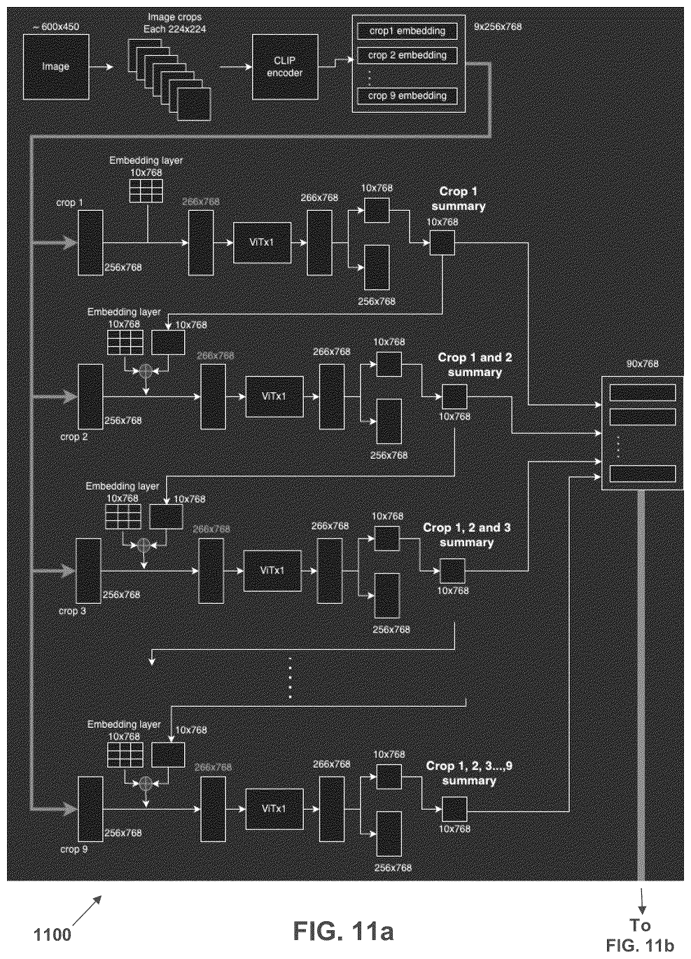

FIG. 10 illustrates a baseline example embodiment of a machine learning model 1000. Tracking through the various components of model 100 starting in the top left of FIG. 10, an input high resolution image of size (600×450) or (1100×700), for example, may be cropped to a size of 224×224 at or near its center, or model 1000 may takes a center crop of a slightly larger size (˜300×300) and then resize it to 224×224 such that the final size of the image is 224×224.

This image is then passed to a CLIP encoder of model 1000. The CLIP encoder encodes the 224×224 image to a size of 256×768 for embedding. These embeddings may then concatenated with 10 (for example) visual prompt embeddings which are learnable/trainable. This increases the total embeddings to 266×768. These 266×768 embeddings are passed through trainable ViT (vision transformer) layers. A total of eight trainable ViT layers are used in this example. The top 10×768 embeddings are taken from the output of the final ViT layer. These 10×768 embeddings are provided from layer number 3 (Layer 3 in FIG. 10) to a last transformer layer. Within each layer, these 10×768 embeddings are then added (addition) to the new learnable 10×768 embeddings. The text and/or instructions are provided to the transformer similar to traditional transformers.

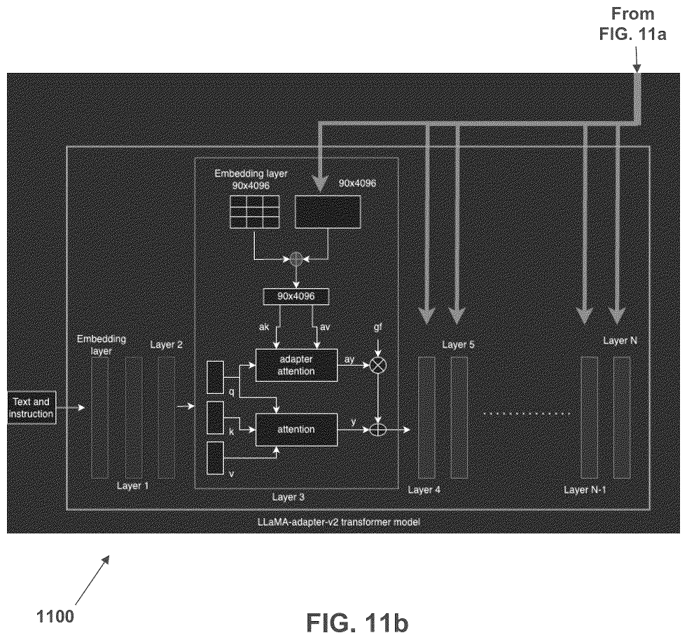

FIG. 11a and FIG. 11b illustrate an enhanced machine learning model 1100 relative to model 1000 shown in FIG. 10, with various architectural modifications and additions. Model 1100 is configured to summarize (e.g., generate an output for) each crop (e.g., block) and add crop summary embeddings sequentially to the next crop. Tracking through the various components of model 1100 starting in the top left of FIG. 11a, a ˜(600×450) image, for example, may be minimally resized to have its length and width be a multiple of 224. Then 224×224 crops may be extracted from the image. In this example, if the number of crops generated is less than 9, then a zero value crop (e.g., a black colored crop) may be appended to the crops to make a total of 9 crops. If the number of crops generated is more than 9, then crop selection may be truncated at a 9th patch (with a patch being a unit of subdivision of a crop in this example). Patch selection may start from the top left of the image and proceed to right until the end of the image and then down, for a total of 9 patches here. Each crop is 224×224. Each crop is passed through the CLIP encoder independently, and an embedding of 256×768 is obtained for each. A total number of embeddings obtained is 9×256×768.

A first crop (see Crop 1) embedding (256×768) may be concatenated with 10 new learnable/trainable embeddings to create 266×768 embeddings. Each crop processing may have 10×768 new learnable/trainable embeddings associated with it, in this example. These 266×768 embeddings of the first crop are passed through one trainable ViT layer. This single ViT layer outputs an embedding of size 266×768. The first 10×768 embeddings from these ViT outputs are saved and passed to the next crop (see Crop 2, 3, etc.) for processing further. This 10×768 ViT output from the first crop is added (in this instance) to the learnable/trainable embeddings of a second crop (Crop 2). The second crop embedding (256×768) is concatenated with the above 10×768 embedding (which is a mixture of the first crop's 10×768 ViT output and the second crop's 10×768 learnable embeddings), which results in an embedding of size 266×768. This is passed again through one ViT layer (this is a new ViT layer and not the one which was used for crop 1), and 266×768 output embeddings are obtained from this ViT layer. The first 10×768 embeddings from this ViT layer are saved and transferred to the next crop. This process of processing each crop then saving its 10×768 ViT output embeddings and passing it to the next goes on until all the crops (e.g., blocks ad described above) are processed.

Finally, all of the nine (in this example) saved crop embeddings from the ViT layer are concatenated to create an embedding of size 90×768. This 90×768 embedding is passed from layer 3 shown in FIG. 11 to a final transformer layer. Within each layer, projection of these 90×768 embeddings are then added (addition) to the new learnable 90×4096 embeddings. The text and/or instructions are provided to the transformer similar to traditional transformers.

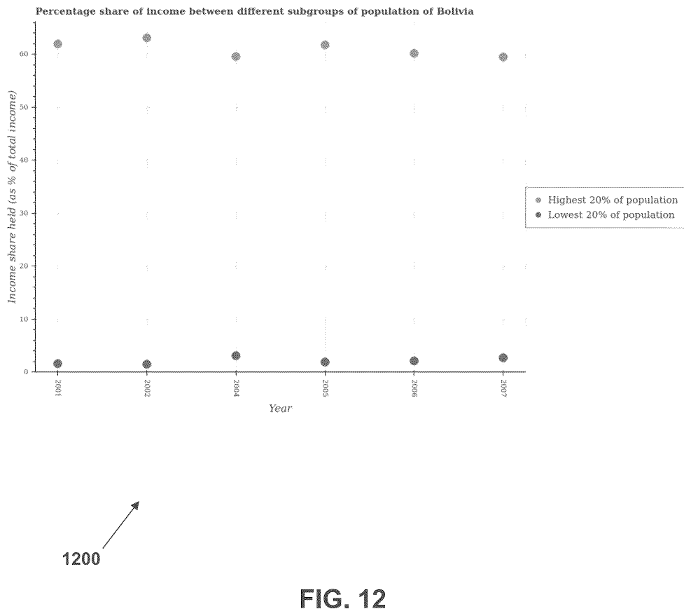

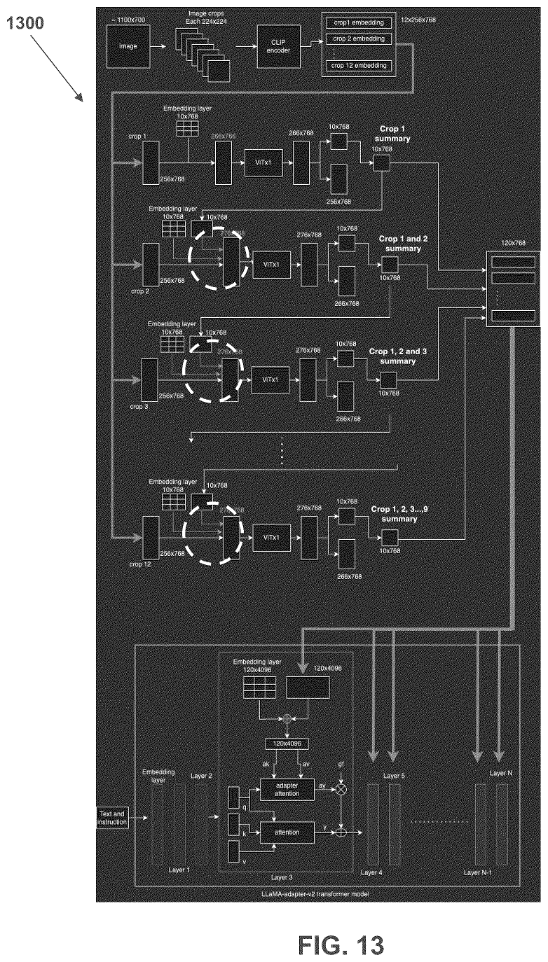

FIG. 12 illustrates an image 1200 of a plot or graph that may be used as an input to a machine learning model. FIG. 13 illustrates a machine learning model 1300 (e.g., a machine learning model similar to model 1100 shown in FIG. 11a/11b and described above, but note the circled side by side arrows in FIG. 13 compared to the corresponding arrow combinations shown in FIG. 11a) that may be used to process image 1200. The machine learning model 1300 is configured to summarize (e.g., generate an output for) each crop (e.g., block) and concatenate (e.g., provide) crop summary embeddings sequentially to the next crop. Image 1200 may be an ˜(1100×700) image that is minimally resized to have a length and a width which are multiples of 224. Then 224×224 crops may be extracted from image 1200. If the number of crops generated is less than 12 (in this example), then a zero value crop (black colored crop) may be appended to the crops to make a total of 12 crops. If the number of crops generated is more than 12, then the crop selection may be truncated at the 12th patch, for example (again with a patch being a subdivision of a crop). Patch selection may start from the top left of image 1200 and proceed to the right until the end of image 1200 and then down, for a total of 12 patches. Each crop may be 224×224 in this example. Each crop is passed through an image encoder (e.g. CLIP, pix2struct) independently and an embedding of 256×768 is obtained for each, so that total embeddings obtained are 12×256×768.

A first crop embedding (256×768) may be concatenated with 10 new learnable/trainable embeddings to create 266×768 embeddings. Each crop processing may have 10×768 new learnable/trainable embeddings associated with it. These 266×768 embeddings of the first crop are passed through one trainable ViT layer. This single ViT layer outputs an embedding of size 266×768. The first 10×768 embeddings from these ViT outputs are saved and passed to the next crop for processing further. These 10×768 ViT output from the 1st crop is concatenated to the learnable/trainable embeddings of a second crop to create an embedding of size 20×768. The second crop embedding (256×768) is concatenated with the above 20×768 embedding (which is a mixture of the first crop's 10×768 ViT output and the second crop's 10×768 learnable embeddings), which results in an embedding of size 276×768. This is passed again through one ViT layer (this is a new ViT layer and not the one which was used for crop 1), which generates 276×768 output embeddings from this ViT layer. The first 10×768 embeddings from this ViT layer are saved and transferred to the next crop. This process of processing each crop then saving its 10×768 ViT output embeddings and passing it to the next goes on until all the crops are processed.

Finally, all 12 saved crop embeddings from the ViT layer are concatenated to create an embedding of size 120×768. This 120×768 embedding is passed from layer 3 to a final transformer layer. Within each layer, these 120×768 embeddings are then added (addition) to the new learnable 120×768 embeddings. The text and/or instructions are provided to the transformer similar to traditional transformers.

FIG. 14 is a diagram that illustrates an exemplary computer system 1400 in accordance with embodiments of the present system. Various portions of systems and methods described herein may include or be executed on one or more computer systems the same as or similar to computer system 1400. For example, processing engine 12, mobile user device 34, mobile user device 36, desktop user device 38, external resources 46 and/or other components of system 10 (FIG. 1) may be and/or include one more computer systems the same as or similar to computer system 1400. Further, processes, modules, processor components, and/or other components of system 10 described herein may be executed by one or more processing systems similar to and/or the same as that of computer system 1400.

Computer system 1400 may include one or more processors (e.g., processors 1410a-1410n) coupled to system memory 1420, an input/output I/O device interface 1430, and a network interface 1440 via an input/output (I/O) interface 1450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 1400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1420). Computer system 1400 may be a uni-processor system including one processor (e.g., processor 1410a), or a multi-processor system including any number of suitable processors (e.g., 1410a-1410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 1400 may include a plurality of computing devices (e.g., distributed computer systems) to implement various processing functions.

I/O device interface 1430 may provide an interface for connection of one or more I/O devices 1460 to computer system 1400. I/O devices may include devices that receive input (e.g., from a user) or output information (e.g., to a user). I/O devices 1460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1460 may be connected to computer system 1400 through a wired or wireless connection. I/O devices 1460 may be connected to computer system 1400 from a remote location. I/O devices 1460 located on a remote computer system, for example, may be connected to computer system 1400 via a network N and network interface 1440.

Network interface 1440 may include a network adapter that provides for connection of computer system 1400 to network N. Network interface May 1440 may facilitate data exchange between computer system 1400 and other devices connected to the network. Network interface 1440 may support wired or wireless communication. The network may include an electronic communication network, such as the Internet, a local area network (LAN), a wide area network (WAN), a cellular communications network, or the like.

System memory 1420 may be configured to store program instructions 1470 or data 1480. Program instructions 1470 may be executable by a processor (e.g., one or more of processors 1410a-1410n) to implement one or more embodiments of the present techniques. Instructions 1470 may include modules and/or components (e.g., components 16, 18, and/or 20 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1420 may include a non-transitory computer readable storage medium that may have program instructions stored thereon that are executable by a computer processor (e.g., one or more of processors 1410a-1410n) to cause the subject matter and the functional operations described herein. A memory (e.g., system memory 1420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1450 may be configured to coordinate I/O traffic between processors 1410a-1410n, system memory 1420, network interface 1440, I/O devices 1460, and/or other peripheral devices. I/O interface 1450 may perform protocol, timing, or other data transformations to convert data signals from one component (e.g., system memory 1420) into a format suitable for use by another component (e.g., processors 1410a-1410n). I/O interface 1450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1400 or multiple computer systems 1400 configured to host different portions or instances of embodiments. Multiple computer systems 1400 may provide for parallel or sequential processing/execution of one or more portions of the techniques described herein.

Those skilled in the art will appreciate that computer system 1400 is merely illustrative and is not intended to limit the scope of the techniques described herein. Computer system 1400 may include any combination of devices or software that may perform or otherwise provide for the performance of the techniques described herein. For example, computer system 1400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 1400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

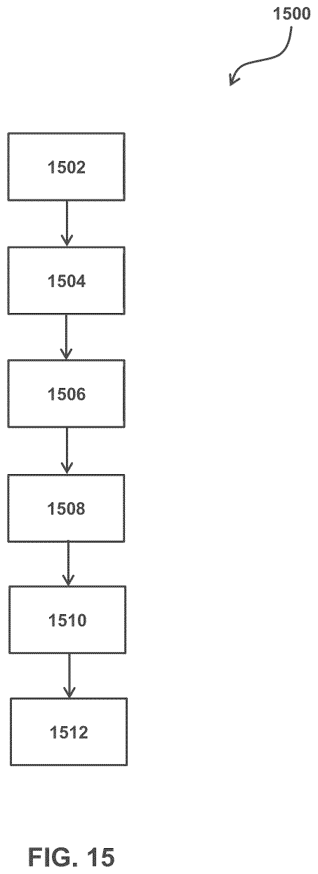

FIG. 15 is a flowchart of a method 1500 that provides long range attention in a machine learning model for an input comprising any mode of data, and/or otherwise facilitates training a neural network of the machine learning model, with a longer sequence length compared to training of prior neural networks, by dividing an input sequence length into N smaller blocks to mitigate computational complexity, and subsequently merging the smaller blocks to retain long-range context, as described herein. Method 1500 may be performed with some embodiments of system 10 (FIG. 1), computer system 1400 (FIG. 14), and/or other components discussed above. Method 1500 may include additional operations that are not described, and/or may not include one or more of the operations described below. The operations of method 1500 may be performed in any order that provides long range attention in a machine learning model for an input comprising any mode of data, and/or otherwise facilitates training a neural network of the machine learning model with a longer sequence length compared to training of prior neural networks, as described herein.

Method 1500 begins with operation 1502, comprising receiving an input (X) with a layer of a neural network. The input comprises a sequence having an input sequence length (ξ) and an embedding size (C). The sequence may comprise characters, words, phrases, image pixels, an audio recording, radar data, a spectrogram, data bytes, and/or other units. Each unit of a sequence is converted into a vector and provided to the layer. The vector may be called a token, for example. The neural network may comprise at least a portion of a large language model. In some embodiments, the neural network comprises a transformer module of the large language model, for example. The layer of the neural network may be a multi-head attention layer of the transformer module.

Operation 1504 includes dividing the input into N blocks (X₀, X₁, etc.), with each of the N blocks comprising a sequence length that is shorter than the input sequence length. In some embodiments, the multi-head attention layer described above comprises multiple self-attention modules, each self-attention module associated with one of the N blocks. These multiple self-attention modules are configured to operate in parallel.

Operation 1506 comprises determining an initial key (K₀), query (Q₀), and value (V₀) of a first (X₀) of the N blocks, and determining an initial key (K₁), query (Q₁) and value (V₁) of a next (X₁) of the N blocks. In some embodiments, the N blocks are split into key, query, and/or value using separate linear layers of the neural network.

Operation 1508 comprises determining a first block output (\hat{X}₀) for the first (X₀) of the N blocks based on the initial key (K₀), query (Q₀), and value (V₀) of the first (X₀) of the N blocks. In some embodiments, determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.

Operation 1510 comprises providing the first block output (\hat{X}₀) as input for determining a next block output (\hat{X}₁) for the next (X₁) of the N blocks. The next block output (\hat{X}₁) is determined based on the first block output (\hat{X}₀), and the initial key (K₁), query (Q₁), and value (V₁) of the next (X₁) of the N blocks. For example, in some embodiments, determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (Xᵢ₋₁); and then performing a second Norm+Softmax operation using output from the first Norm+Softmax operation, a value (Vᵢ) of the next (Xᵢ) of the N blocks, and the output from the previous block (Xᵢ₋₁).

Operation 1512 comprises repeating operations 1502-1510 for each remaining block of the N blocks, such that, for each block (Xᵢ), each next block output (\hat{X}ᵢ) is output from a previous block (Xᵢ₋₁), thus merging smaller blocks to retain long-range context associated with the input. A block output coming from previous sequence blocks comprises collective information from all previous sequence blocks. Operations 1502-1512 facilitate training the neural network with a longer sequence length compared to training of prior neural networks, by dividing the sequence length into smaller blocks to mitigate computational complexity, and subsequently merging the smaller blocks to retain long-range context.

In some embodiments, instead of feeding a sequence of blocks together, to separate self-attention modules, method 1500 is configured such that parameters from one self-attention module are shared for all sequence blocks, such that a block output is fed back to a self-attention module as a hidden state for a next sequence block.

In some embodiments, method 1500 comprises providing a memory line. The memory line is configured to ensure sustained influence of one or more initial blocks of the N blocks, and to establish equal importance for each block in a sequence of N blocks. In some embodiments, the memory line is configured to assimilate information from a current output through a self-attention module. The information is appended to the input of subsequent blocks (Xᵢ). In some embodiments, the memory line is configured to obtain information from a present self-attention module and subsequently determine which information should be transmitted to a next self-attention module. In some embodiments, the memory line comprises an adaptation of a Long Short-Term Memory (LSTM) neural network, and/or Gated Recurrent Units (GRUs). In some embodiments, the memory line computation is independent of a number of heads in a multi-head attention layer. In some embodiments, operations 1502-1512 reduce K, Q, V multiply and accumulate operations from 3(ξ×C²)+2(ξ²×C) to 6(ξ×C²)+2(ξ²/N×C) and reduce multiply and accumulate operations because of matrix multiplications in “Norm+SoftMax” blocks by a factor of N.

Once trained (e.g., using operation 1502-1512), the neural network may be deployed to output responses to new user prompts (e.g., inputs). In some embodiments, deployment and/or use of the trained neural network may also be considered a part of method 1500, for example.

As described above, method 1500 may include additional operations that are not described, and/or may not include one or more of the operations described below. As an example, in some embodiments, a simplified version of method 1500 may include dividing the input into N blocks (e.g., operation 1504); determining a first block output for a first of the N blocks (e.g., operation 1508); providing the first block output as input for determining a next block output for a next of the N blocks (e.g., operation 1510); and repeating these operations for each remaining block, such that each next block output is determined based on output from a previous block, thus merging smaller blocks to retain context associated with the input and provide the long range attention in the machine learning model (e.g., operation 1512). Other variations are contemplated.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A non-transitory computer readable medium having instructions thereon, the instructions when executed by a computer causing the computer to perform operations that provide long range attention in a machine learning model for an input comprising any mode of data, the operations comprising: (a) dividing the input into N blocks, each of the N blocks comprising a sequence length that is shorter than an input sequence length, the input received with a layer of a neural network of the machine learning model, the input comprising a sequence having the input sequence length; (b) determining a first block output for a first of the N blocks; (c) providing the first block output as input for determining a next block output for a next of the N blocks; and (d) repeating operations (b)-(c) for each remaining block, such that each next block output is determined based on output from a previous block, thus merging smaller blocks to retain context associated with the input and provide the long range attention in the machine learning model.
2. The medium of embodiment 1, wherein operations (a)-(e) facilitate providing the neural network with longer sequence lengths compared to what was possible with prior neural networks, by dividing the sequence length into smaller blocks to mitigate computational complexity, and subsequently merging the smaller blocks to retain the context associated with the input and provide the long range attention.
3. The medium of any of the previous embodiments, wherein a block output coming from multiple previous blocks comprises collective information from all of the multiple previous blocks.
4. The medium of any of the previous embodiments, wherein the input comprises text, numerical data, one or more images, an audio recording, radar data, and/or a spectrogram.
5. The medium of any of the previous embodiments, wherein the operations further comprise converting the input into the sequence, the sequence having units associated with the input, a quantity of the units comprising the input sequence length.
6. The medium of any of the previous embodiments, wherein the operations further comprise converting each unit of the sequence into a vector and providing each vector to the layer.
7. The medium of any of the previous embodiments, wherein the neural network comprises a transformer module of a large language model.
8. The medium of any of the previous embodiments, wherein the layer of the neural network comprises a multi-head attention layer of the transformer module.
9. The medium of any of the previous embodiments, wherein the multi-head attention layer comprises multiple self-attention modules, each self-attention module associated with one of the N blocks.
10. The medium of any of the previous embodiments, wherein the multiple self-attention modules are configured to operate in parallel.
11. A method for providing long range attention in a machine learning model for an input comprising any mode of data, the method comprising: (a) dividing the input into N blocks, each of the N blocks comprising a sequence length that is shorter than an input sequence length, the input received with a layer of a neural network of the machine learning model, the input comprising a sequence having the input sequence length; (b) determining a first block output for a first of the N blocks; (c) providing the first block output as input for determining a next block output for a next of the N blocks; and (d) repeating operations (b)-(c) for each remaining block, such that each next block output is determined based on output from a previous block, thus merging smaller blocks to retain context associated with the input and provide the long range attention in the machine learning model.
12. The method of embodiment 11, wherein operations (a)-(e) facilitate providing the neural network with longer sequence lengths compared to what was possible with prior neural networks, by dividing the sequence length into smaller blocks to mitigate computational complexity, and subsequently merging the smaller blocks to retain the context associated with the input and provide the long range attention.
13. The method of any of the previous embodiments, wherein a block output coming from multiple previous blocks comprises collective information from all of the multiple previous blocks.
14. The method of any of the previous embodiments, wherein the input comprises text, numerical data, one or more images, an audio recording, radar data, and/or a spectrogram.
15. The method of any of the previous embodiments, further comprising converting the input into the sequence, the sequence having units associated with the input, a quantity of the units comprising the input sequence length.
16. The method of any of the previous embodiments, further comprising converting each unit of the sequence into a vector and providing each vector to the layer.
17. The method of any of the previous embodiments, wherein the neural network comprises a transformer module of a large language model.
18. The method of any of the previous embodiments, wherein the layer of the neural network comprises a multi-head attention layer of the transformer module.
19. The method of any of the previous embodiments, wherein the multi-head attention layer comprises multiple self-attention modules, each self-attention module associated with one of the N blocks.
20. The method of any of the previous embodiments, wherein the multiple self-attention modules are configured to operate in parallel.
21. A non-transitory computer readable medium having instructions thereon, the instructions when executed by a computer causing the computer to perform operations comprising: (a) receiving an input (X) with a layer of a neural network, the input comprising a sequence having an input sequence length (ξ); (b) dividing the input into N blocks (X₀, X₁, . . . , Xᵢ), each of the N blocks comprising a sequence length that is shorter than the input sequence length; (c) determining an initial key (K₀), query (Q₀), and value (V₀) of a first (X₀) of the N blocks; (d) determining an initial key (K₁), query (Q₁) and value (V₁) of a next (X₁) of the N blocks; (e) determining a first block output (\hat{X}₀) for the first (X₀) of the N blocks based on the initial key (K₀), query (Q₀), and value (V₀) of the first (X₀) of the N blocks; and (f) providing the first block output (\hat{X}₀) as input for determining a next block output (\hat{X}₁) for the next (X₁) of the N blocks, the next block output (\hat{X}₁) determined based on the first block output (\hat{X}₀), and the initial key (K₁), query (Q₁), and value (V₁) of the next (X₁) of the N blocks; wherein operations (a)-(f) facilitate training the neural network with a longer sequence length compared to training of prior neural networks, by dividing the sequence length into smaller blocks to mitigate computational complexity, and subsequently merging the smaller blocks to retain long-range context.
22. The medium of embodiment 21, the operations further comprising: (g) repeating operations (d)-(f) for each remaining block of the N blocks, such that, for each block (Xᵢ), each next block output (\hat{X}ᵢ) is output from a previous block (Xᵢ₋₁), thus merging smaller blocks to retain long-range context associated with the input.
23. The medium of any of the previous embodiments, wherein the neural network comprises at least a portion of a large language model.
24. The medium of any of the previous embodiments, wherein the neural network comprises a transformer module.
25. The medium of any of the previous embodiments, wherein the layer of the neural network comprises a multi-head attention layer of the transformer module.
26. The medium of any of the previous embodiments, wherein the multi-head attention layer comprises multiple self-attention modules, each self-attention module associated with one of the N blocks.
27. The medium of any of the previous embodiments, wherein the multiple self-attention modules are configured to operate in parallel.
28. The medium of any of the previous embodiments, wherein determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.
29. The medium of any of the previous embodiments, wherein determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁).
30. The medium of any of the previous embodiments, wherein the N blocks are split into key, query, and/or value using separate linear layers of the neural network.
31. The medium of any of the previous embodiments, wherein the input comprises the sequence length and an embedding size (C).
32. The medium of any of the previous embodiments, wherein operations (a)-(f) reduce K, Q, V multiply and accumulate operations from 3(ξ×C²)+2(ξ²×C) to 3(ξ×C²)+2(ξ²/N×C) and reduce multiply and accumulate operations because of matrix multiplications in “Norm+SoftMax” blocks by a factor of N.
33. The medium of any of the previous embodiments, wherein a block output coming from previous sequence blocks comprises collective information from all previous sequence blocks.
34. The medium of any of the previous embodiments, wherein, instead of feeding a sequence of blocks together, to separate self-attention modules, parameters from one self-attention module are shared for all sequence blocks, such that a block output is fed back to a self-attention module as a hidden state for a next sequence block.
35. The medium of any of the previous embodiments, further comprising providing a memory line.
36. The medium of any of the previous embodiments, wherein the memory line is configured to ensure sustained influence of one or more initial blocks of the N blocks, and to establish equal importance for each block in a sequence of N blocks.
37. The medium of any of the previous embodiments, wherein the memory line is configured to assimilate information from a current output through a self-attention module, and wherein the information is appended to the input of subsequent blocks (Xᵢ).
38. The medium of any of the previous embodiments, wherein the memory line is configured to obtain information from a present self-attention module and subsequently determine which information should be transmitted to a next self-attention module.
39. The medium of any of the previous embodiments, wherein the memory line comprises an adaptation of a Long Short-Term Memory (LSTM) neural network, and/or Gated Recurrent Units (GRUs).
40. The medium of any of the previous embodiments, wherein a memory line computation is independent of a number of heads in a multi-head attention layer.
41. A method, comprising: (a) receiving an input (X) with a layer of a neural network, the input comprising a sequence having an input sequence length (ξ); (b) dividing the input into N blocks (X₀, X₁, etc.), each of the N blocks comprising a sequence length that is shorter than the input sequence length; (c) determining an initial key (K₀), query (Q₀), and value (V₀) of a first (X₀) of the N blocks, (d) determining an initial key (K₁), query (Q₁) and value (V₁) of a next (X₁) of the N blocks; (e) determining a first block output (\hat{X}₀) for the first (X₀) of the N blocks based on the initial key (K₀), query (Q₀), and value (V₀) of the first (X₀) of the N blocks; and (f) providing the first block output (\hat{X}₀) as input for determining a next block output (\hat{X}₁) for the next (X₁) of the N blocks, the next block output (\hat{X}₁) determined based on the first block output (\hat{X}₀), and the initial key (K₁), query (Q₁), and value (V₁) of the next (X₁) of the N blocks; wherein operations (a)-(f) facilitate training the neural network with a longer sequence length compared to training of prior neural networks, by dividing the sequence length into smaller blocks to mitigate computational complexity, and subsequently merging the smaller blocks to retain long-range context.
42. The method of embodiment 41, the method further comprising: (g) repeating operations (d)-(f) for each remaining block of the N blocks, such that, for each block (Xᵢ), each next block output (\hat{X}ᵢ) is output from a previous block (Xᵢ₋₁), thus merging smaller blocks to retain long-range context associated with the input.
43. The method of any of the previous embodiments, wherein the neural network comprises at least a portion of a large language model.
44. The method of any of the previous embodiments, wherein the neural network comprises a transformer module.
45. The method of any of the previous embodiments, wherein the layer of the neural network comprises a multi-head attention layer of the transformer module.
46. The method of any of the previous embodiments, wherein the multi-head attention layer comprises multiple self-attention modules, each self-attention module associated with one of the N blocks.
47. The method of any of the previous embodiments, wherein the multiple self-attention modules are configured to operate in parallel.
48. The method of any of the previous embodiments, wherein determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.
49. The method of any of the previous embodiments, wherein determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁).
50. The method of any of the previous embodiments, wherein the N blocks are split into key, query, and/or value using separate linear layers of the neural network.
51. The method of any of the previous embodiments, wherein the input comprises the sequence length and an embedding size (C).
52. The method of any of the previous embodiments, wherein operations (a)-(f) reduce K, Q, V multiply and accumulate operations from 3(ξ×C²)+2(ξ²×C) to 3(ξ×C²)+2(ξ²/N×C) and reduce multiply and accumulate operations because of matrix multiplications in “Norm+SoftMax” blocks by a factor of N.
53. The method of any of the previous embodiments, wherein a block output coming from previous sequence blocks comprises collective information from all previous sequence blocks.
54. The method of any of the previous embodiments, wherein, instead of feeding a sequence of blocks together, to separate self-attention modules, parameters from one self-attention module are shared for all sequence blocks, such that a block output is fed back to a self-attention module as a hidden state for a next sequence block.
55. The method of any of the previous embodiments, the method further comprising providing a memory line.
56. The method of any of the previous embodiments, wherein the memory line is configured to ensure sustained influence of one or more initial blocks of the N blocks, and to establish equal importance for each block in a sequence of N blocks.
57. The method of any of the previous embodiments, wherein the memory line is configured to assimilate information from a current output through a self-attention module, and wherein the information is appended to the input of subsequent blocks (Xᵢ).
58. The method of any of the previous embodiments, wherein the memory line is configured to obtain information from a present self-attention module and subsequently determine which information should be transmitted to a next self-attention module.
59. The method of any of the previous embodiments, wherein the memory line comprises an adaptation of a Long Short-Term Memory (LSTM) neural network, and/or Gated Recurrent Units (GRUs).
60. The method of any of the previous embodiments, wherein a memory line computation is independent of a number of heads in a multi-head attention layer.
61. A long range block attention system comprising one or more processors and a non-transitory machine readable medium, the medium storing instructions which, when executed by the one or more processors, cause the one or more processors to perform the method of any of the previous embodiments.

What is claimed is:

1. A non-transitory computer readable medium having instructions thereon, the instructions when executed by a computer causing the computer to perform operations that provide long range attention in a machine learning model for an input comprising any mode of data, the operations comprising:
(a) dividing the input into N blocks, each of the N blocks comprising a sequence length that is shorter than an input sequence length, the input received with a layer of a neural network of the machine learning model, the input comprising a sequence having the input sequence length;
(b) determining a first block output for a first of the N blocks;
(c) providing the first block output as input for determining a next block output for a next of the N blocks; and
(d) repeating operations (b)-(c) for each remaining block, such that each next block output is determined based on output from a previous block, thus merging smaller blocks to retain context associated with the input and provide the long range attention in the machine learning model.

2. The medium of claim 1, wherein operations (a)-(e) facilitate providing the neural network with longer sequence lengths compared to what was possible with prior neural networks, by dividing the sequence length into smaller blocks to mitigate computational complexity, and subsequently merging the smaller blocks to retain the context associated with the input and provide the long range attention.

3. The medium of claim 1, wherein a block output coming from multiple previous blocks comprises collective information from all of the multiple previous blocks.

4. The medium of claim 1, wherein the input comprises text, numerical data, one or more images, an audio recording, radar data, and/or a spectrogram.

5. The medium of claim 1, wherein the operations further comprise converting the input into the sequence, the sequence having units associated with the input, a quantity of the units comprising the input sequence length.

6. The medium of claim 1, wherein the operations further comprise converting each unit of the sequence into a vector and providing each vector to the layer.

7. The medium of claim 1, wherein the neural network comprises a transformer module of a large language model.

8. The medium of claim 7, wherein the layer of the neural network comprises a multi-head attention layer of the transformer module.

9. The medium of claim 8, wherein the multi-head attention layer comprises multiple self-attention modules, each self-attention module associated with one of the N blocks.

10. The medium of claim 9, wherein the multiple self-attention modules are configured to operate in parallel.

11. A method for providing long range attention in a machine learning model for an input comprising any mode of data, the method comprising:
(a) dividing the input into N blocks, each of the N blocks comprising a sequence length that is shorter than an input sequence length, the input received with a layer of a neural network of the machine learning model, the input comprising a sequence having the input sequence length;
(b) determining a first block output for a first of the N blocks;
(c) providing the first block output as input for determining a next block output for a next of the N blocks; and
(d) repeating operations (b)-(c) for each remaining block, such that each next block output is determined based on output from a previous block, thus merging smaller blocks to retain context associated with the input and provide the long range attention in the machine learning model.

12. The method of claim 11, wherein operations (a)-(e) facilitate providing the neural network with longer sequence lengths compared to what was possible with prior neural networks, by dividing the sequence length into smaller blocks to mitigate computational complexity, and subsequently merging the smaller blocks to retain the context associated with the input and provide the long range attention.

13. The method of claim 11, wherein a block output coming from multiple previous blocks comprises collective information from all of the multiple previous blocks.

14. The method of claim 11, wherein the input comprises text, numerical data, one or more images, an audio recording, radar data, and/or a spectrogram.

15. The method of claim 11, further comprising converting the input into the sequence, the sequence having units associated with the input, a quantity of the units comprising the input sequence length.

16. The method of claim 11, further comprising converting each unit of the sequence into a vector and providing each vector to the layer.

17. The method of claim 11, wherein the neural network comprises a transformer module of a large language model.

18. The method of claim 17, wherein the layer of the neural network comprises a multi-head attention layer of the transformer module.

19. The method of claim 18, wherein the multi-head attention layer comprises multiple self-attention modules, each self-attention module associated with one of the N blocks.

20. The method of claim 19, wherein the multiple self-attention modules are configured to operate in parallel.

21. A non-transitory computer readable medium having instructions thereon, the instructions when executed by a computer causing the computer to perform operations comprising:
(e) receiving an input (X) with a layer of a neural network, the input comprising a sequence having an input sequence length (ξ);
(f) dividing the input into N blocks (X₀, X₁, . . . , Xᵢ), each of the N blocks comprising a sequence length that is shorter than the input sequence length;
(g) determining an initial key (K₀), query (Q₀), and value (V₀) of a first (X₀) of the N blocks,
(h) determining an initial key (K₁), query (Q₁) and value (V₁) of a next (X₁) of the N blocks;
(e) determining a first block output (\hat{X}₀) for the first (X₀) of the N blocks based on the initial key (K₀), query (Q₀), and value (V₀) of the first (X₀) of the N blocks; and
(f) providing the first block output (\hat{X}₀) as input for determining a next block output (\hat{X}₁) for the next (X₁) of the N blocks, the next block output (\hat{X}₁) determined based on the first block output (\hat{X}₀), and the initial key (K₁), query (Q₁), and value (V₁) of the next (X₁) of the N blocks;
wherein operations (a)-(f) facilitate training the neural network with a longer sequence length compared to training of prior neural networks, by dividing the sequence length into smaller blocks to mitigate computational complexity, and subsequently merging the smaller blocks to retain long-range context.

22. The medium of claim 21, the operations further comprising:
(g) repeating operations (d)-(f) for each remaining block of the N blocks, such that, for each block (Xᵢ), each next block output (\hat{X}ᵢ) is output from a previous block (Xᵢ₋₁), thus merging smaller blocks to retain long-range context associated with the input.

23. The medium of claim 21, wherein the neural network comprises at least a portion of a large language model.

24. The medium of claim 21, wherein the neural network comprises a transformer module.

25. The medium of claim 24, wherein the layer of the neural network comprises a multi-head attention layer of the transformer module.

26. The medium of claim 25, wherein the multi-head attention layer comprises multiple self-attention modules, each self-attention module associated with one of the N blocks.

27. The medium of claim 26, wherein the multiple self-attention modules are configured to operate in parallel.

28. The medium of claim 21, wherein determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.

29. The medium of claim 21, wherein determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁).

30. The medium of claim 21, wherein the N blocks are split into key, query, and/or value using separate linear layers of the neural network.

31. The medium of claim 21, wherein the input comprises the sequence length and an embedding size (C).

32. The medium of claim 31, wherein operations (a)-(f) reduce K, Q, V multiply and accumulate operations from 3(ξ×C²)+2(ξ²×C) to 3(ξ×C²)+2(ξ²/N×C) and reduce multiply and accumulate operations because of matrix multiplications in “Norm+SoftMax” blocks by a factor of N.

33. The medium of claim 21, wherein a block output coming from previous sequence blocks comprises collective information from all previous sequence blocks.

34. The medium of claim 21, wherein, instead of feeding a sequence of blocks together, to separate self-attention modules, parameters from one self-attention module are shared for all sequence blocks, such that a block output is fed back to a self-attention module as a hidden state for a next sequence block.

35. The medium of claim 21, further comprising providing a memory line.

36. The medium of claim 35, wherein the memory line is configured to ensure sustained influence of one or more initial blocks of the N blocks, and to establish equal importance for each block in a sequence of N blocks.

37. The medium of claim 35, wherein the memory line is configured to assimilate information from a current output through a self-attention module, and wherein the information is appended to the input of subsequent blocks (Xᵢ).

38. The medium of claim 35, wherein the memory line is configured to obtain information from a present self-attention module and subsequently determine which information should be transmitted to a next self-attention module.

39. The medium of claim 35, wherein the memory line comprises an adaptation of a Long Short-Term Memory (LSTM) neural network, and/or Gated Recurrent Units (GRUs).

40. The medium of claim 35, wherein a memory line computation is independent of a number of heads in a multi-head attention layer.

41. A method, comprising:
(i) receiving an input (X) with a layer of a neural network, the input comprising a sequence having an input sequence length (ξ);
(j) dividing the input into N blocks (X₀, X₁, etc.), each of the N blocks comprising a sequence length that is shorter than the input sequence length;
(k) determining an initial key (K₀), query (Q₀), and value (V₀) of a first (X₀) of the N blocks,
(l) determining an initial key (K₁), query (Q₁) and value (V₁) of a next (X₁) of the N blocks;
(h) determining a first block output (\hat{X}₀) for the first (X₀) of the N blocks based on the initial key (K₀), query (Q₀), and value (V₀) of the first (X₀) of the N blocks; and
(i) providing the first block output (\hat{X}₀) as input for determining a next block output (\hat{X}₁) for the next (X₁) of the N blocks, the next block output (\hat{X}₁) determined based on the first block output (\hat{X}₀), and the initial key (K₁), query (Q₁), and value (V₁) of the next (X₁) of the N blocks;
wherein operations (a)-(f) facilitate training the neural network with a longer sequence length compared to training of prior neural networks, by dividing the sequence length into smaller blocks to mitigate computational complexity, and subsequently merging the smaller blocks to retain long-range context.

42. The method of claim 41, the method further comprising:
(j) repeating operations (d)-(f) for each remaining block of the N blocks, such that, for each block (Xᵢ), each next block output (\hat{X}ᵢ) is output from a previous block (Xᵢ₋₁), thus merging smaller blocks to retain long-range context associated with the input.

43. The method of claim 41, wherein the neural network comprises at least a portion of a large language model.

44. The method of claim 41, wherein the neural network comprises a transformer module.

45. The method of claim 44, wherein the layer of the neural network comprises a multi-head attention layer of the transformer module.

46. The method of claim 45, wherein the multi-head attention layer comprises multiple self-attention modules, each self-attention module associated with one of the N blocks.

47. The method of claim 46, wherein the multiple self-attention modules are configured to operate in parallel.

48. The method of claim 41, wherein determining the first block output (\hat{X}₀) for the first (X₀) of the N blocks comprises performing a first Norm+Softmax operation using the initial key (K₀) and query (Q₀), and then performing a second Norm+Softmax operation using output from the first Norm+Softmax operation and the initial value (V₀) of the first (X₀) of the N blocks.

49. The method of claim 41, wherein determining a next block output (\hat{X}ᵢ) for a next (Xᵢ) of the N blocks, comprises performing a first Norm+Softmax operation using a key (Kᵢ) for the next block and a query (Qᵢ) for the next block, and output from a previous block (\hat{X}ᵢ₋₁); and then performing a second Norm+Softmax operation using output from the first Norm+Softmax operation, a value (Vᵢ) of the next (Xᵢ) of the N blocks, and the output from the previous block (\hat{X}ᵢ₋₁).

50. The method of claim 41, wherein the N blocks are split into key, query, and/or value using separate linear layers of the neural network.

51. The method of claim 41, wherein the input comprises the sequence length and an embedding size (C).

52. The method of claim 51, wherein operations (a)-(f) reduce K,Q, V multiply and accumulate operations from 3(ξ×C²)+2(ξ²×C) to 3(ξ×C²)+2(ξ²/N×C) and reduce multiply and accumulate operations because of matrix multiplications in “Norm+SoftMax” blocks by a factor of N.

53. The method of claim 41, wherein a block output coming from previous sequence blocks comprises collective information from all previous sequence blocks.

54. The method of claim 41, wherein, instead of feeding a sequence of blocks together, to separate self-attention modules, parameters from one self-attention module are shared for all sequence blocks, such that a block output is fed back to a self-attention module as a hidden state for a next sequence block.

55. The method of claim 41, the method further comprising providing a memory line.

56. The method of claim 55, wherein the memory line is configured to ensure sustained influence of one or more initial blocks of the N blocks, and to establish equal importance for each block in a sequence of N blocks.

57. The method of claim 55, wherein the memory line is configured to assimilate information from a current output through a self-attention module, and wherein the information is appended to the input of subsequent blocks (Xᵢ).

58. The method of claim 55, wherein the memory line is configured to obtain information from a present self-attention module and subsequently determine which information should be transmitted to a next self-attention module.

59. The method of claim 55, wherein the memory line comprises an adaptation of a Long Short-Term Memory (LSTM) neural network, and/or Gated Recurrent Units (GRUs).

60. The method of claim 55, wherein a memory line computation is independent of a number of heads in a multi-head attention layer.

61. A long range block attention system comprising one or more processors and a non-transitory machine readable medium, the medium storing instructions which, when executed by the one or more processors, cause the one or more processors to perform the method of any of claims 11-20 and/or 41-60.
